(19) United States
(12) Patent Application Publication
(10) Pub. No.: US 2025/0280347 A1
(43) Pub. Date: Sep. 4, 2025

(54) METHOD AND USER EQUIPMENT FOR HANDLING CONDITIONAL HANDOVER IN NON-TERRESTRIAL NETWORK

(71) Applicant: Samsung Electronics Co., Ltd., Suwon-si (KR)

(72) Inventors: Vivek MURUGAIYAN, Bangalore (IN); Nishant, Bangalore (IN); Amit Anandrao DANGE, Bangalore (IN); Kailash Kumar JHA, Bangalore (IN)

(21) Appl. No.: 18/925,707

(22) Filed: Oct. 24, 2024

Related U.S. Application Data
(63) Continuation of application No. PCT/KR2024/015613, filed on Oct. 15, 2024.

(30) Foreign Application Priority Data
Mar. 1, 2024 (KR) 202441015357

(51) Int. Cl. H04W 36/36; H04W 36/00; H04W 64/00

(52) U.S. Cl. CPC H04W 36/362; H04W 36/0085; H04W 64/003

(57) ABSTRACT

Embodiments herein provide a method performed by a user equipment (UE) for handling a conditional handover (CHO) in non-terrestrial network (NTN). The method includes receiving, by the UE, CHO configuration information associated with one or more target candidate cells. The CHO configuration information includes a signal measurements-based event and one of a timer-based event or a distance-based event. Further, starting a measurement for one of the timer-based event or the distance-based event associated with the one or more target candidate cells at a first time instance. Also, determining whether the measurement for one of the timer-based event or the distance-based event is completed. Furthermore, the method includes performing a measurement for the signal measurements-based event associated with the one or more target candidate cells at a second time instance, in accordance with a determination that the measurement for one of the time-based based event or the distance-based event is completed.

### CROSS-REFERENCE TO RELATED APPLICATIONS

This application is a continuation of International Application No. PCT/KR2024/015613 designating the United States, filed on Oct. 15, 2024, in the Korean Intellectual Property Receiving Office and claiming priority to Indian Patent Application No. 202441015357, filed on Mar. 1, 2024, in the Indian Patent Office, the disclosures of each of which are incorporated by reference herein in their entireties.

### BACKGROUND

### Field

The disclosure relates to a field of wireless communication technology and Non-Terrestrial Network (NTN). For example, the disclosure relates to a method and user equipment for handling conditional handover in non-terrestrial network.

### Description of Related Art

An NTN refers to a network or segment of network that uses a spaceborne vehicle or an airborne vehicle. For example, the spaceborne vehicle may include but not limited to a Low Earth Orbiting (LEO) satellite, a Medium Earth Orbiting (MEO) satellite, a Geostationary Earth Orbiting satellite (GEO), and Highly Elliptical Orbiting (HEO) satellite. Also, the airborne vehicle may include but not limited to a High-Altitude Platform (HAP) encompassing Unmanned Aircraft Systems (UAS) which includes Lighter than Air UAS (LTA) and Heavier than Air UAS (HTA).

The 3rd Generation Partnership Project (3GPP) has incorporated NTN and satellite segments into the 5G connectivity ecosystem as part of the release 17. The NTN deployment includes two variations, namely earth-fixed cells and earth-moving cells. In the former, the satellite sweeps across the earth's surface while the cells and footprints of the satellite beams remain static. Also, in the earth fixed cell, mobility of UEs and RRC connections between both satellites takes place in overlap area between the serving and next satellite coverage in which each satellite provides a earth fixed cell. Also, for the LEO/HAPS in the earth fixed cell, on board antenna with steerable beam capability is deployed. Similarly, for GEO in earth fixed cell on board antenna without steerable beam capability is deployed. In the latter, the satellite moves along with the cells and beam footprints on the earth's surface. In earth moving cell, mobility between cells happens such that UEs are handed over gradually from cell to cell when they get covered by a new cell provided by the same or by the next satellite. Also, for the LEO/HAPS in the earth moving cell, on board antenna without steer able beam capability is deployed. Also, for the GEO in the earth moving cell, on board antenna with steerable beam capability is deployed. During the connected mode, a serving NTN cell can transmit a conditional handover configuration to a User Equipment (UE) associated with one or more target candidate cells. The UE performs the Conditional Handover (CHO) between the serving cell and one or more target candidate cells when one or more handover conditions are met. Each target candidate cell contains conditional reconfiguration that is applied by the serving cell to perform the handover when one or more conditional events corresponding to the conditional reconfiguration is satisfied. Additionally, the release 19 introduced a System Information Block (SIB 19) that defines NTN-specific parameters for the serving cell and one or more target candidate cells. The SIB includes NTN-specific parameters such as t-service, distance threshold reference point and others. The distance threshold is a Distance from the reference location and used in location-based measurement initiation to indicate the service area of serving cell. Also, the reference point is a Reference location of the serving cell indicates the ellipsoid point (latitude, longitude) on the earth which intended to indicate the serving area of the NTN cell and used in location-based measurement initiation. The t-service parameter indicates the time at which the NTN-earth fixed cell will stop serving the area it currently covers.

In the realm of connected mode mobility within the NTN network, a new conditional event has been incorporated into the conditional handover and measurement event. Among these new conditional events are distance-based (D1) and timer-based (T1) events. The distance-based event serves to convey the distance of the UE from a reference point, while the time-based event denotes the UE time surpassing a threshold time.

In the current state of the art, when a conditional events configured in UE for conditional handover, the UE initiates an evaluation process to determine whether one or more candidate cells meet the necessary conditions for the handover from the serving cell. These conditions are defined by a conditional configuration that specifies one or more conditional events for each candidate cell, which can be signal-based, distance-based, or time-based for NTN cell. The UE then conducts signal measurements and time/distance-based measurements simultaneously for each NTN candidate cell. Furthermore, the UE successfully performs the handover to a candidate cell only if all of the specified conditional events are satisfied.

In the current state of the art, 3GPP has not prescribed a specific methodology for conducting signal and time/distance-based measurements. As a result, the UE undertakes a continuous measurement of signals and time/distance simultaneously when both time or distance based event along with signal based event configured in UE. Similarly, for connected mode measurement report, the network can configure both signal and distance-based reporting conditions for the same NTN candidate cell. The UE measures both distance-based and signal measurements and sends the measurement report from the time when the event is configured. However, in certain scenarios conditional handover configuration and measurement report configuration, even if the signal measurement-based events are fulfilled, the distance-based or time-based events may not be satisfied. In such cases, the UE's signal measurement leads to excessive resource usage and higher power consumption. Therefore, an improper selection of time instances to perform signal and time/distance measurements during conditional handover leads to inefficient resource planning and more power consumption. Consequently, it is imperative to address the aforementioned drawbacks or other limitations or provide a useful alternative.

### SUMMARY

Embodiments of the disclosure provide a method and user equipment for handling conditional handover in NTN. The disclosure entails the user equipment obtaining conditional handover configuration information linked to one or more target candidate cells. The user equipment initiates a timer-based or distance-based event associated with the target candidate cell(s) at a specified time instance. The user equipment conducts signal measurements. As a result, the disclosure establishes a defined time instance and periodicity for signal measurements to be carried out on the target candidate cells in NTN environment during the UE's conditional handover.

Embodiments of the disclosure establish a specific time instance and periodicity for conducting signal measurements on potential target cells for connected mode mobility. This is based on the UE mobility state, t-service value of the serving NTN cell, and time/distance related events associated with the same target candidate NTN cells.

Embodiments of the disclosure establish a specific point in time and periodicity for conducting signal measurements on a potential target NTN cell. This is based on a time-based event that is linked to the same target NTN cell, facilitating conditional handover implementation.

Embodiments of the disclosure employ both distance-based and time-based event conditions, linked to a given neighbouring candidate NTN cell, the t-service timer of the serving NTN cell, and the mobility state of the UE. This is utilized to determine the appropriate timer instance and periodicity for conducting signal measurements of the neighbouring NTN cell while in connected mode.

Embodiments of the disclosure establish a specific time frame and periodicity for conducting signal and distance-based measurement events of a target candidate NTN cell, based on the t-service timer of the serving NTN cell, in cases where the user equipment remains stationary for conditional handover and measurement event.

Embodiments of the disclosure establish a specific moment and periodicity for conducting signal measurements on a potential target NTN cell. This is determined by the t-service timer of the serving NTN cell and a distance-based event linked to the same target NTN cell, both of which are taken into account when the UE is in motion and a conditional handover and measurement event is executed in connected mode.

According to an example embodiment, a method for handling conditional handover in a non-terrestrial network (NTN) is provided. The method includes: receiving, by a user equipment (UE), Conditional Handover (CHO) configuration information associated with one or more target candidate cells, wherein the CHO configuration information includes a signal measurements-based event and one of a timer-based event or a distance-based event; starting, by the UE, one of the timer-based event or the distance-based event associated with the one or more target candidate cell at a first-time instance; determining, by the UE, whether one of the timer-based event or the distance-based event is completed; and performing, by the UE, the signal-measurements-based event associated with the one or more target candidate cell at a second time instance, based on one of the time-based based event or the distance-based event being completed.

In an example embodiment, the method includes: determining, by the UE, whether an entry condition for the signal measurements-based event and one of the timer-based event or the distance-based event is completed; performing, by the UE, a CHO procedure from a source cell to a selected target candidate cell of the one or more target candidate cells, based on the entry condition for the signal measurements-based event and one of the timer-based event or the distance-based event being completed; and performing measurement configuration from a source cell to a selected target candidate cell of the one or more target candidate cells, based on the entry condition for the signal measurements-based event and the distance-based event being completed.

In an example embodiment, the CHO configuration information includes the timer-based event based on the UE being in a connected mode for 5G services. The CHO configuration information includes the distance-based event based on the UE being in connected mode for 5G services and the UE is in at least one of a mobility state and a stationary state.

In an example embodiment, performing the signal measurements-based event at the second time instance, the method includes: determining, by the UE, whether the UE is in one of a mobility state or a stationary state; performing, by the UE, based on the UE being in the mobility state, determining the second instance and a periodicity of the signal-based measurement event for the one or more target candidate cells for the UE in the mobility state; the UE performing the signal-measurements-based event associated with the one or more target candidate cell at the second time instance based on the determined periodicity; based on UE being in the stationary state, determining the second instance and a periodicity of the signal-based measurement event for the one or more target candidate cells for the UE in the stationary state; and performing the signal-measurements-based event associated with the one or more target candidate cell at the second time instance based on the determined periodicity.

In an example embodiment the method includes receiving CHO configuration information associated with one or more target candidate cells. The CHO configuration information includes a signal measurements-based event and a distance-based event based on the UE being in a connected mode for 5G services and the UE is in a stationary state. The method includes: skipping, by the UE, the distance-based event associated with the one or more target candidate cell at a first-time instance; determining, by the UE, whether a t-service timer meets a t-service timer expiry threshold; and starting, by the UE, the signal-measurements-based event associated with the one or more target candidate cell at a second time instance, based on the t-service timer being about to expire.

In an example embodiment, the method includes: determining, by the UE, whether an entry condition for the signal measurements-based event and the distance-based event is completed; and performing, by the UE, a CHO procedure from a source cell to a selected target candidate cell of the one or more target candidate cells based on the entry condition for the signal measurements-based event and the distance-based event being completed.

In an example embodiment, the method of performing the signal measurement-based event at the second time instance includes: determining whether the UE is in one of a mobility state or a stationary state; based on the UE being in mobility state, determining the second instance and a periodicity of the signal-based measurement event for the one or more target candidate cells for the UE in the mobility state; performing the signal-measurements-based event associated with the one or more target candidate cell at the second time instance based on the determined periodicity; wherein based on the UE being in the stationary state, determining the second instance and a periodicity of the signal-based measurement event for the one or more target candidate cells for the UE in the stationary state; and performing the signal-measurements-based event associated with the one or more target candidate cell at the second time instance based on the determined periodicity.

In an example embodiment, the method of determining whether the entry conditions for timer-based event is completed comprises: comparing, by the UE, current time of the UE while performing timer-based event with a preconfigured threshold time; and determining, the completion of the timer-based event based on the current time of the UE being greater than or equal to a specified threshold time.

In an example embodiment, the method of determining whether the entry conditions for distance-based event is completed comprises: determining, by the UE, distance between a current location of the UE with respect to a first reference location and second reference location; and determining, by the UE, completion of the distance-based event based on at least one of the distance between the current location of the UE and first reference location being greater than a specified first threshold of the first reference location and distance between the current location of the UE and second reference point being shorter than a specified second threshold of the second reference location.

In an example embodiment, the method of performing measurement configuration from a source cell to a selected target candidate cell of the one or more target candidate cells comprises: determining, by the UE, whether the UE is in one of a mobility state or a stationary state; performing based on the UE being in stationary state, skipping the distance-based event; and performing at least one of signal-measurements-based event with reduced periodicity until the t-service timer is about expire for the serving cell and performing the signal-measurements-based event with increased periodicity based on the t-service timer being about to expire; and based on the UE being in mobility state, performing the distance-based event continuously and, performing the signal-measurements-based event with reduced periodicity until the distance-based event is determined to be completed.

According to an example embodiment, a method may be performed by a user equipment (UE) for handling a conditional handover (CHO) in non-terrestrial network (NTN). The method may comprise receiving, by the UE, CHO configuration information associated with one or more target candidate cells, wherein the CHO configuration information includes a signal measurements-based event and one of a timer-based event or a distance-based event. The method may comprise starting, by the UE, a measurement for one of the timer-based event or the distance-based event associated with the one or more target candidate cells at a first time instance. The method may comprise determining, by the UE, whether the measurement for one of the timer-based event or the distance-based event is completed. The method may comprise performing, by the UE, a measurement for the signal measurements-based event associated with the one or more target candidate cells at a second time instance, in accordance with a determination that the measurement for one of the timer-based event or the distance-based event is completed.

According to an example embodiment, a user equipment (UE) for handling a conditional handover (CHO) in non-terrestrial network (NTN) may comprise at least one processor comprising processing circuitry. The UE may comprise memory, comprising one or more storage media, storing instructions. Wherein the instructions, when executed by the at least one processor individually or collectively, may cause the UE to receive CHO configuration information associated with one or more target candidate cells, wherein the CHO configuration information includes a signal measurements-based event and one of a timer-based event or a distance-based event. Wherein the instructions, when executed by the at least one processor individually or collectively, may cause the UE to start a measurement for one of the timer-based event or the distance-based event associated with the one or more target candidate cells at a first time instance. Wherein the instructions, when executed by the at least one processor individually or collectively, may cause the UE to determine whether the measurement for one of the timer-based event or the distance-based event is completed. Wherein the instructions, when executed by the at least one processor individually or collectively, may cause the UE to perform a measurement for the signal-measurements-based event associated with the one or more target candidate cells at a second time instance, in accordance with a determination that the measurement for one of the time-based based event or the distance-based event being completed.

According to an example embodiment, A method performed by a user equipment (UE) for handling a conditional handover (CHO) in non-territorial network (NTN) may comprise receiving, by the UE, CHO configuration information associated with one or more target candidate cells, wherein the CHO configuration information includes a signal measurements-based event and a distance-based event based on the UE being in a connected mode for 5G services and the UE being in a stationary state. The method may comprise skipping, by the UE, a measurement for the distance-based event associated with the one or more target candidate cells at a first time instance. The method may comprise determining, by the UE, whether a t-service timer meets a t-service timer expiry threshold. The method may comprise starting, by the UE, a measurement for the signal measurements-based event associated with the one or more target candidate cells at a second time instance, in accordance with a determination that the t-service timer meets the t-service timer expiry threshold.

According to an example embodiment, A user equipment (UE) for handling a conditional handover (CHO) in non-territorial network (NTN) may comprise at least one processor comprising processing circuitry. The UE may comprise memory, comprising one or more storage media, storing instructions. Wherein the instructions, when executed by the at least one processor individually or collectively, cause the UE to receive CHO configuration information associated with one or more target candidate cells, wherein the CHO configuration information includes a signal measurements-based event and a distance-based event based on the UE being in a connected mode for 5G services and the UE being in a stationary state. Wherein the instructions, when executed by the at least one processor individually or collectively, cause the UE to skip a measurement for the distance-based event associated with the one or more target candidate cells at a first time instance. Wherein the instructions, when executed by the at least one processor individually or collectively, cause the UE to determine whether a t-service timer meets a t-service timer expiry threshold. Wherein the instructions, when executed by the at least one processor individually or collectively, cause the UE to start a measurement for the signal measurements-based event associated with the one or more target candidate cells at a second time instance, in accordance with a determination that the t-service timer meets the t-service timer expiry threshold.

Accordingly, an example embodiment provides a User Equipment (UE) configured to handle conditional handover in a non-terrestrial network (NTN). The User Equipment comprises: at least one processor, comprising processing circuitry, and an event handler comprising circuitry. The event handler is configured to receive Conditional Handover (CHO) configuration information associated with one or more target candidate cells. The CHO configuration information includes a signal measurements-based event and one of a timer-based event or a distance-based event. Further, the event handler is configured to start one of the timer-based event or the distance-based event associated with the one or more target candidate cell at a first-time instance. Furthermore, the event handler is configured to determine whether one of the timer-based event or the distance-based event is completed. Thereafter, the event handler is configured to perform the signal-measurements-based event associated with the one or more target candidate cell at a second time instance, based on one of the time-based based event or the distance-based event being completed.

These and other aspects of the various example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications be made within the scope of the embodiments herein.

### BRIEF DESCRIPTION OF THE DRAWINGS

These and other features, aspects, and advantages of certain embodiments of the present disclosure are illustrated in the accompanying drawings, throughout which like reference letters indicate corresponding parts in the various figures. The embodiments herein will be better understood from the following detailed description taken in conjunction with the accompanying drawings, in which:

FIG. 1A is a diagram illustrating different types of Nom-Terrestrial networks (NTN), according to the prior art;

FIG. 1B is a diagram illustrating signal strength characteristics of both terrestrial and non-terrestrial networks, according to the prior art;

FIG. 1C is a signal flow diagram illustrating a process of conditional handover in the NTN, according to the prior art;

FIG. 1D is a diagram illustrating an example scenario in which a distance-based event during CHO of the UE in the NTN, according to the prior art;

FIG. 1E is a diagram illustrating an example scenario in which time-based event during conditional handover of the UE in the NTN, according to the prior art;

FIG. 1F is a diagram illustrating an example scenario of time-based event and signal measurements-based event during a CHO of the UE in NTN, according to the prior art;

FIG. 1G is a flowchart illustrating a method of conditional handover of the UE with a timer-based event, according to the prior art;

FIG. 1H is a diagram illustrating an example scenario of distance-based event and signal measurements-based event during a CHO of the stationary UE in NTN, according to the prior art;

FIG. 1I is a diagram illustrating an example scenario of distance-based event and signal measurements-based event during a CHO of mobile UE in NTN, according to the prior art;

FIG. 1J is a flowchart illustrating a method of conditional handover of the mobile UE with a distance-based event, according to the prior art;

FIG. 1K is a diagram illustrating an example scenario of distance-based event and signal measurements-based event during a measurement event of UE in NTN, according to the prior art;

FIG. 1L is a flowchart illustrating a method of performing signal measurement and distance measurements of neighbor NTN cells, according to the prior art;

FIG. 2 is a block diagram illustrating an example configuration of a user equipment for handling conditional handover in NTN, according to various embodiments;

FIG. 3A is a diagram illustrating an example scenario in which the conditional handover of UE is managed through a timer-based event, according to various embodiments;

FIG. 3B is a flowchart illustrating an example method of handling conditional handover of UE with a timer-based event, according to various embodiments;

FIG. 4A is a diagram illustrating a scenario in which the conditional handover of a stationary UE is managed through a distance-based event, according to various embodiments;

FIG. 4B is a flowchart illustrating an example method of handling conditional handover of stationary UE with a distance-based event, according to various embodiments;

FIG. 5A is a diagram illustrating a scenario in which the conditional handover of a mobile UE is managed through a distance-based event, according to various embodiments;

FIG. 5B is a flowchart illustrating an example method of handling conditional handover of mobile UE with a distance-based event, according to various embodiments;

FIG. 6A is a diagram illustrating a scenario in which the measurement configuration of a stationary UE is managed through a distance-based event, according to various embodiments;

FIG. 6B is a diagram illustrating a scenario in which measurement configuration of a mobile UE is managed through a distance-based event, according to various embodiments; and

FIG. 6C is a flowchart illustrating an example method of handling measurement configuration with a distance-based event, according to various embodiments.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the disclosure. Furthermore, the elements may have been represented in the drawing by conventional symbols, and the drawings may show those specific details that are pertinent to the understanding the various embodiments so as not to obscure the drawing with details that will be readily apparent to those of ordinary skill in the art having benefit of the description herein.

### DETAILED DESCRIPTION

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The various embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the disclosed method. Likewise, the blocks of the embodiments be physically combined into more complex blocks without departing from the scope of the disclosed method.

The accompanying drawings are used to help easily understand various technical features and it is understood that the embodiments presented herein are not limited by the accompanying drawings. As such, the disclosed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

Accordingly, various embodiments disclose a method for handling conditional handover of a User Equipment (UE) in NTN. The method includes receiving, by a UE, Conditional Handover (CHO) configuration information associated with one or more target candidate cells, wherein the CHO configuration information includes a signal measurements-based event and one of a timer-based event or a distance-based event. Further, the method includes starting, by the UE, one of the timer-based event or the distance-based event associated with the one or more target candidate cell at a first-time instance. Furthermore, the method includes determining, by the UE, whether one of the timer-based event or the distance-based event is completed. Thereafter, the method includes performing, by the UE, the signal-measurements-based event associated with the one or more target candidate cell at a second time instance, when one of the time-based based event or the distance-based event is completed.

Accordingly, the embodiments disclose a user equipment for handling conditional handover in NTN. The user equipment comprises a processor and an event handler. The event handler is configured to receive Conditional Handover (CHO) configuration information associated with one or more target candidate cells. The CHO configuration information includes a signal measurements-based event and one of a timer-based event or a distance-based event. Further, the event handler starts one of the timer-based event or the distance-based event associated with the one or more target candidate cell at a first-time instance. Furthermore, the event handler determines whether one of the timer-based event or the distance-based event is completed. Thereafter, the event handler performs the signal-measurements-based event associated with the one or more target candidate cell at a second time instance, when one of the time-based based event or the distance-based event is completed.

The present disclosure addresses a gap in the 3GPP standard, which fails to specify a method for conducting simultaneous time or distance-based measurements alongside neighbouring NTN cell measurements during conditional handover and measurement configuration. The disclosure focuses on measuring the signal strength of neighbouring NTN cells in connected mode by factoring in the existing time/distance-based conditions and service NTN cell information. Existing methods suffer from the drawback of conducting unnecessary signal measurements of neighbouring NTN cells in connected mode, resulting in increased power consumption without significant improvements in mobility in NTN networks.

The disclosure provides an innovative approach that utilizes distance-based event conditions, time-based event conditions, and the UE mobility state associated with the same neighbour candidate NTN cell, as well as the service timer of the serving NTN cell, to determine the timer instance and periodicity for performing signal measurements of the neighbour NTN cell in connected mode. The disclosure effectively prevents/reduces unnecessary signal measurements while ensuring handover execution in connected mode NTN mobility, thereby ensuring service continuity in NTN networks with enhanced power optimization. Notably, the disclosure helps in terms of maintaining service continuity in NTN networks while optimizing power consumption.

Execution condition in the conditional handover contains one or two measurements ID and both the measurement condition has to be satisfied when candidate cell in the conditional reconfiguration contains two measurement ID. As per 3GPP Specifications TS 38.311 V17.4.0 and TS 38.300 V17.4.0, For CHO if network configures condEventD1 or condEventT1 for a candidate cell, network configures a second triggering event condEventA3, condEventA4 or condEventA5 for the same candidate cell.

The 3GPP standard does not provide any specific guidelines or methods for conducting simultaneous time/distance-based measurements and neighboring NTN cell measurements on a candidate NTN cell. The disclosure may include the UE performing both time/distance-based measurements and neighboring NTN cell signal measurements from the moment the candidate cell is configured in a conditional configuration. Similarly, during connected mode measurements of the NTN cell, one or more reporting configurations can be set up, and the UE will perform both distance-based measurements and signal-based event measurements for the same cell from the time the measurement object and condition are configured.

The disclosure presents a more elegant approach, whereby the UE defines the time instance and periodicity for performing signal measurements on the neighboring NTN cell during connected mode mobility, based on the time and distance conditions associated with the same neighboring NTN cell. This is achieved by utilizing a distance-based event condition, time-based event condition, t-service of the serving NTN cell, and UE mobility state to make a decision on the initiation, periodicity, and gap period for measuring the neighboring NTN cell in connected mode.

The disclosure introduces an optimization of signal measurements on the neighboring NTN cell in connected mode by defining the time instance and gaps for performing neighboring NTN cell measurements. It allows the UE to prevent/reduce power consumption by deploying optimization in connected mode NTN cell measurements, resulting in power-saving enhancements.

In existing techniques, a method for handling a CHO condition in a NTN environment discloses different possible conditions that can be added in conditional events of CHO for NTN network based on its nature of NTN and starting and leaving condition that can be associated with each events with possible additional parameters such as hysteresis.

In another conventional technique, an adaptive measurement procedure for intermitted and overlapping non-terrestrial network coverage is used. However, the existing techniques do not disclose the dependency between signal-based measurement with distance-based measurement event or time based measurement event determine the point of instance and periodicity to perform signal based measurement.

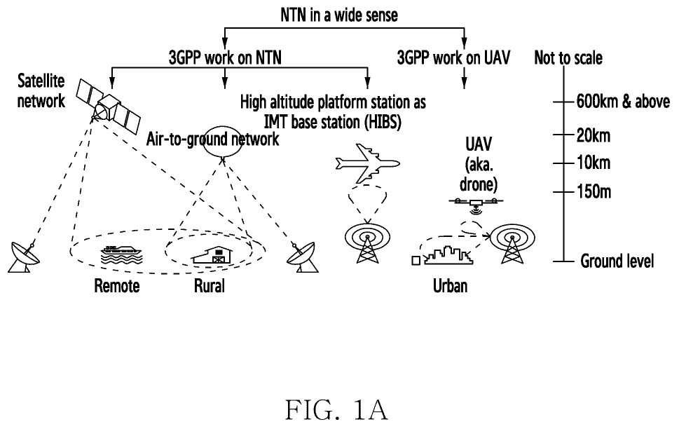

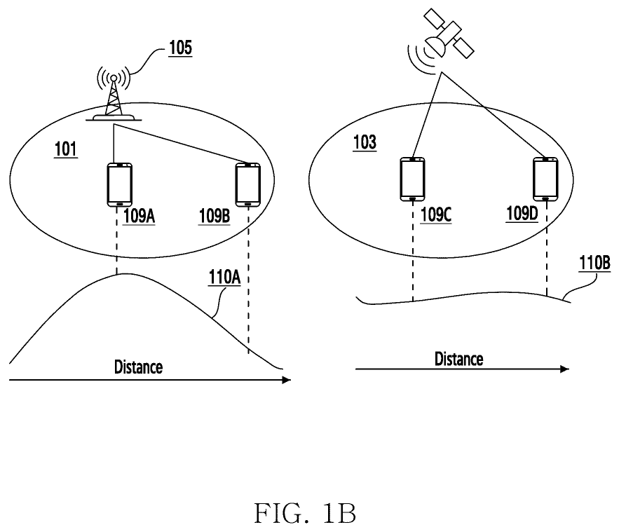

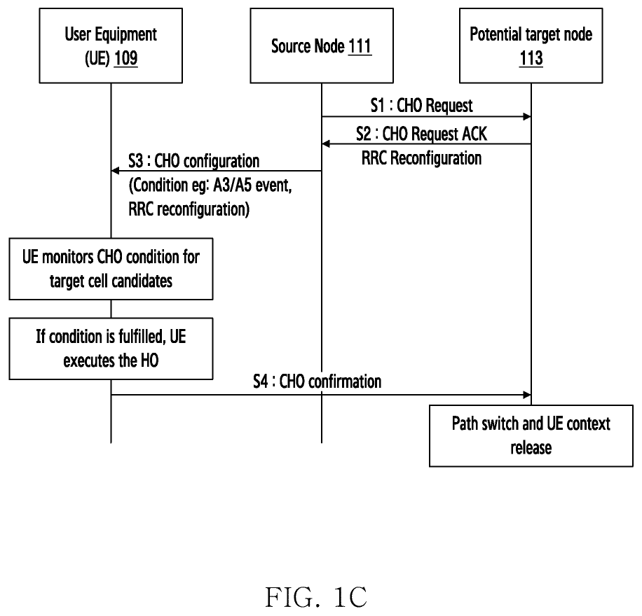

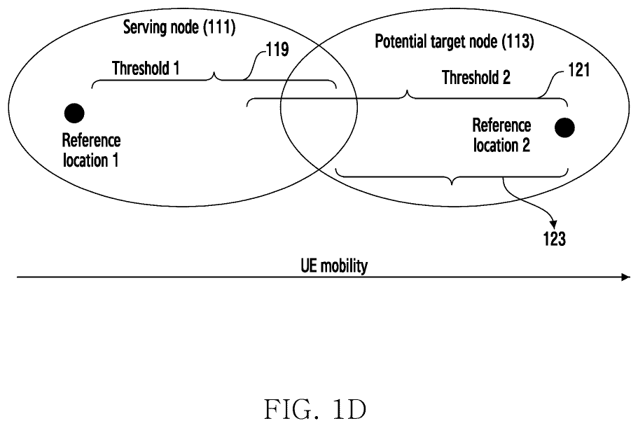

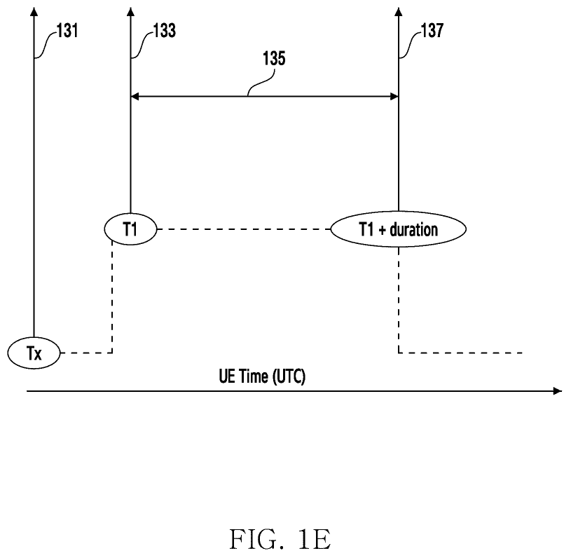

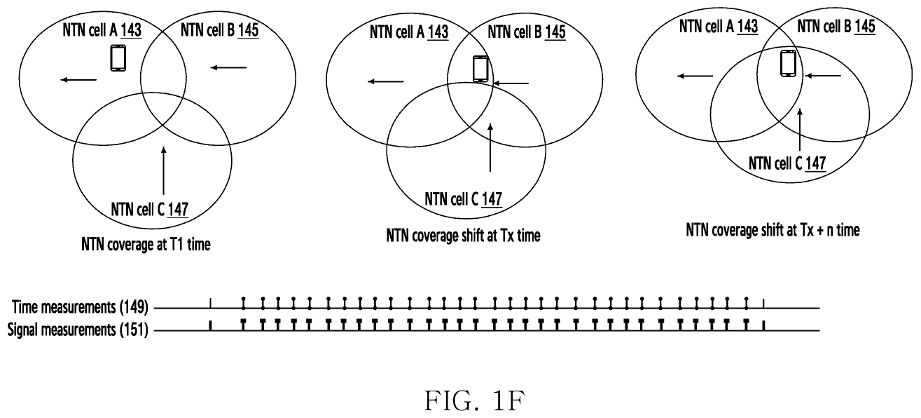

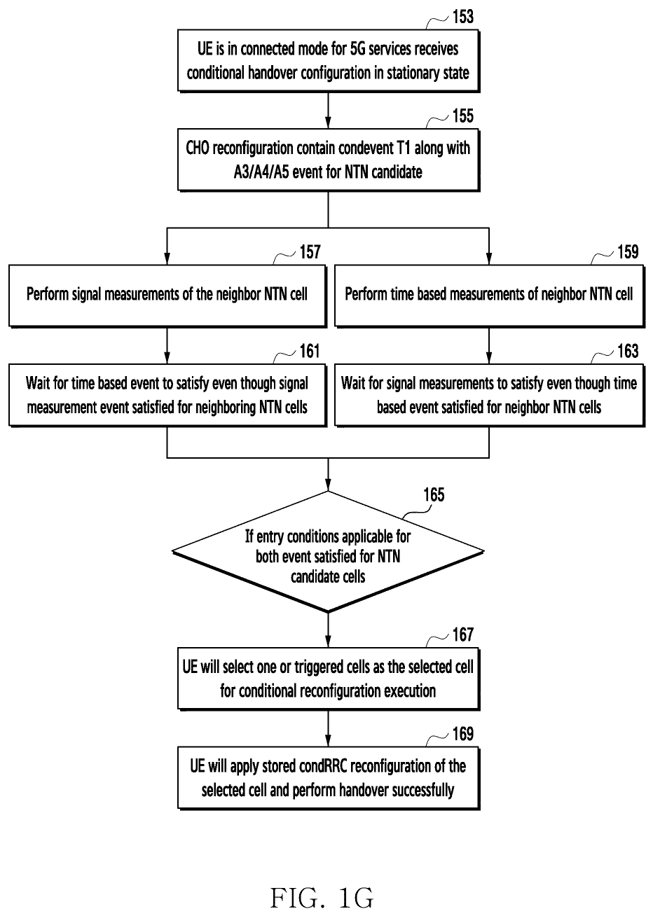

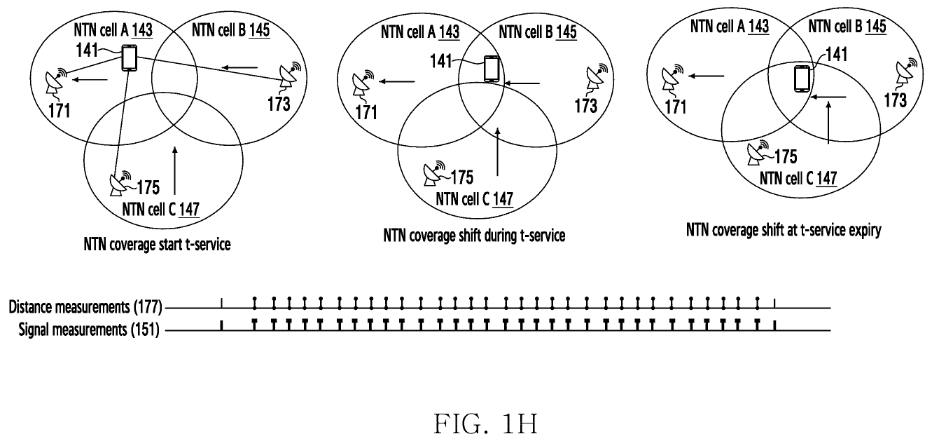

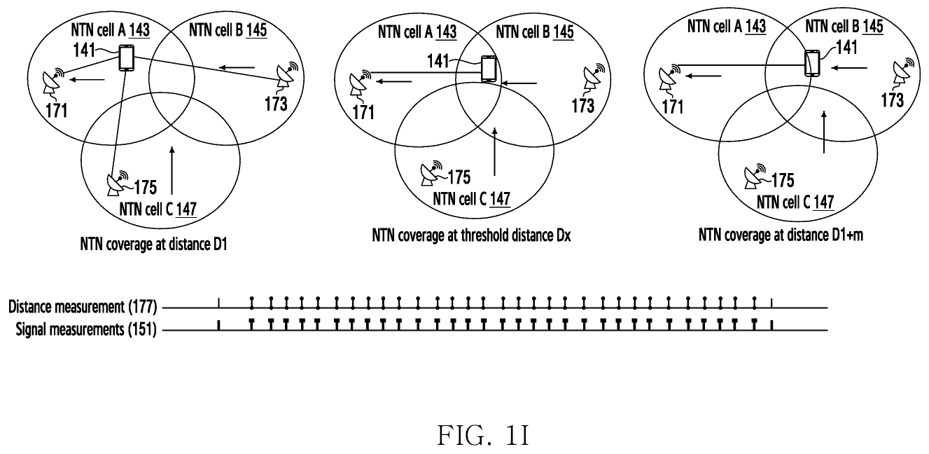

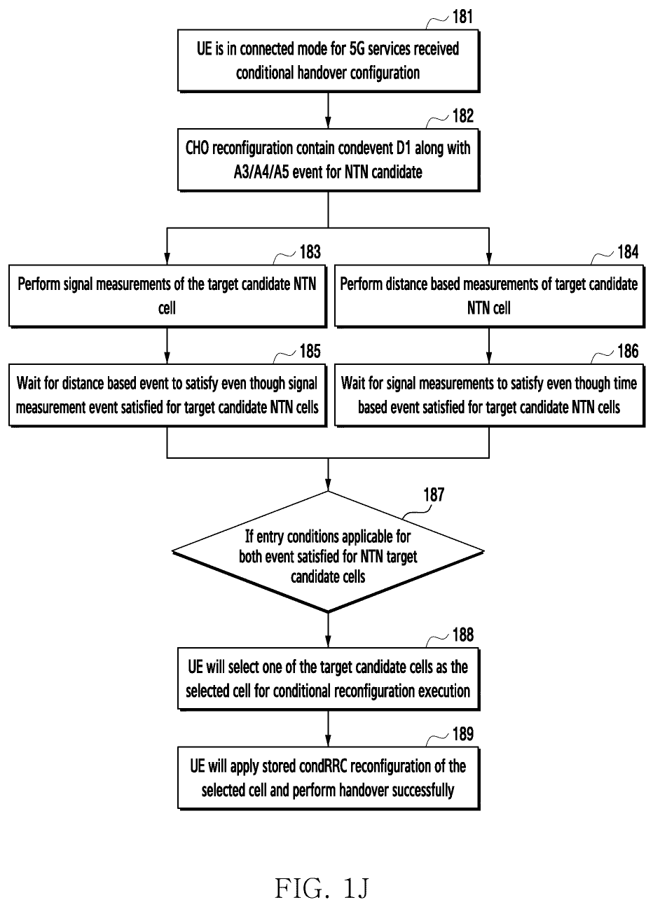

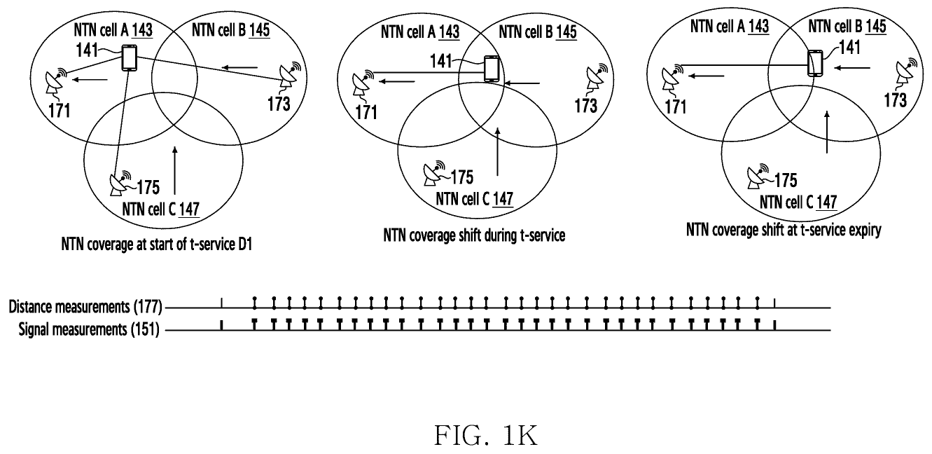

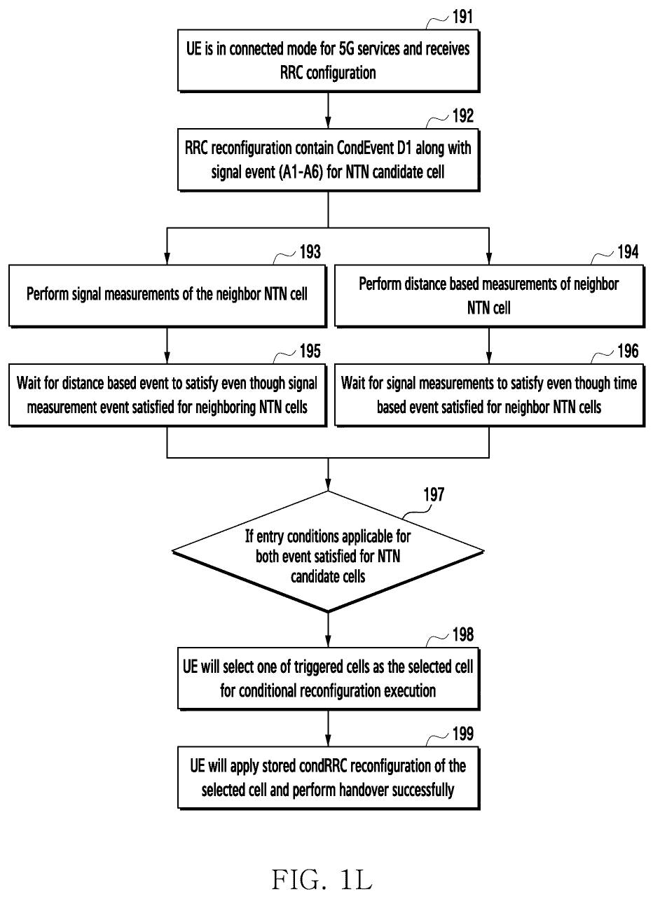

FIG. 1A is a diagram illustrating different types of Nom-Terrestrial networks (NTN), according to the prior art. The NTN is a wireless communication system that operates beyond the Earth's surface. It encompasses various types of networks, including but not limited to satellite communication networks, High Altitude Platform Systems (HAPS), and air-to-ground networks. The satellite communication networks leverage spaceborne platforms, such as Low Earth orbiting (LEO) satellites, Medium Earth Orbiting (MEO) satellites, and Geosynchronous Earth orbiting (GEO) satellites. In addition, the HAPS may involve airplanes, balloons, and airships. Furthermore, the air-to-ground networks provide in-flight connectivity for airplanes by utilizing ground stations that function similarly to base stations (BSs) in terrestrial mobile networks. However, the antennas of the ground stations in an air-to-ground network are tilted towards the sky, and the inter-site distances of the ground stations are much greater than those of terrestrial mobile networks.

FIG. 1B is a diagram illustrating signal strength characteristics of both in terrestrial and NTN, according to the prior art. As shown in FIG. 1B, Consider the scenario depicted in FIG. 1B, wherein a terrestrial network (101) comprises a base station (105) transmitting signals to User Equipments (UEs) (109A) and (109B). The signal strength received by the UEs (109A) and (109B) is contingent upon their proximity to the base station (105). Specifically, the UE (109A) located in close proximity to the base station (105) receives a stronger signal, while the UE (109B) located further away receives a weaker signal. Consequently, the coverage of the signal strength from the base station (105) to the UEs (109A and 109B) varies depending on their distance from the base station (105). This variation is represented by an arc (110A) indicating the range of signal coverage over a particular distance. As such, the signal strength received by the UEs (109A and 109B) in the terrestrial network (101) is subject to fluctuations based on the coverage area of the base station (105).

Consider a NTN, wherein a satellite (107) serves a cell (103) comprising one or more UEs (109C, 109D). The satellite (107) ensures uniform signal strength throughout the coverage area of the cell (103), irrespective of the distance between the one or more UEs (109A, 109B) and the satellite (107). This results in almost uniform signal strength across the coverage area of the NTN network, regardless of the location of the one or more UEs (109A, 109B). As a result, the one or more UEs (109A, 109B) experience similar signal strength from both neighbor and serving cells within the NTN network. The uniform signal strength provided by the satellite (107) in a serving cell (103) is depicted by an arc (110B). Hence, the NTN network offers consistent signal coverage compared to the terrestrial network. Moreover, the NTN network provides global coverage, including remote and sparsely populated areas.

FIG. 1C is a signal flow diagram illustrating a process of conditional handover in the NTN or TN, according to the prior art. In the CHO procedure, at step S1, the UE (109) is being served by a source node (111), which may either be a serving cell or a serving satellite within the NTN or TN. During the conditional handover process, the source node (111) sends a CHO request to a potential target node (113) at step S1. Further, the potential target node (113) accepts the request at step S2 and sends an acknowledgement indicating the acceptance of the CHO request. The potential target node (113) is the node or satellite to which the UE (109) connects as it moves through the NTN.

At step S2, the potential target node (113) also transmits an RRC reconfiguration message to the source node (111). This message facilitates the necessary signaling for the seamless handover of the UE (109) from the source node (111) to the potential target node (113). Furthermore, at step S3, the source node (111) transmits CHO configuration information to the UE (109). This information includes, but is not limited to, one or more conditional events that must be met for the handover to take place from the source node (111) to the potential target node (113). These events may include signal conditional events, distance-based events, timer-based events, and more.

For example, the signal conditional events may be A3/A4/A5 measurement events, among others. Additionally, each CHO configuration information can be configured with one or more conditional events. The CHO configuration appended two conditional events pertain to NTN network, as added in 3GPP TS 38331 release 17, includes several information elements, as shown below:

condEventD1-r17 SEQUENCE {

| | |
|---|---|
| distanceThreshFromReference1-r17 | INTEGER(0.. 65525), |
| distanceThreshFromReference2-r17 | INTEGER(0.. 65525), |

| | |
|---|---|
| referenceLocation1-r17 | ReferenceLocation-r17, |
| referenceLocation2-r17 | ReferenceLocation-r17, |
| hysteresisLocation-r17 | HysteresisLocation-r17, |
| timeToTrigger-r17 | TimeToTrigger |

},
condEventT1-r17 SEQUENCE {

| | |
|---|---|
| t1-Threshold-r17 | INTEGER (0..549755813887), |
| duration-r17 | INTEGER (1..6000) |

}

CondEvent D1 indicates the distance-based event that includes conditions for which the UE (109) has to be meet to perform the handover from source node (111) to the potential target node (113). The distance-based event can be carried out by the UE (109) as shown in FIG. 1D. The condEvent D1 comprises multiple information elements that defines the conditions for the handover of the UE (109). The multiple information elements of the distance-based event can include, but not limited to, distancethreshfromreference1, distancethreshfromreference2, referencelocation1, referencelocation2, and timeToTrigger. The referencelocation1 can be the location in the source node (111) that represents latitude-longitude values on the earth. Similarly, the referencelocation2 can be a location in the potential target node (113) that represents latitude-longitude points on the earth. Also, timeToTrigger specifies a time during which specific criteria for the distance-based event needs to be met in order to execute the conditional reconfiguration evaluation. Further, the distancethreshfromreference1 represents a distance from a reference location 1 associated with source node (111). The maximum distance is represented as threshold 1 (119). Similarly, the distancethreshfromreference2 represents a distance from a reference location 2 associated with potential target node (113) (109). Similarly, referencelocation2 represents a reference location 2 in the potential target node (113). Upon receiving the CHO configuration information, the UE (109) continuously monitors the conditions specified in the CHO configuration information for the potential target node (113). The condition for the UE (109) to perform the handover includes such that, the distance between the location of the UE (109) and reference location 1 should become greater than the configured distancethreshfromreference1 and the distance between the UE (109) and reference location 2 should be lesser than the distancethreshfromreference2. Particularly, the distance (123) indicates the location at which the UE (109) satisfies the distance-based event. Once the defined condition is satisfied, at step S4, the UE (109) sends the CHO confirmation to the potential target node (113). Eventually, the UE (109) performs context release and switches the path to the potential target node (113).

Similarly, the CondEvent T1 indicates the timer-based event that includes conditions for which the UE (109) has to meet to perform the handover from serving node (111) to the potential target node (113). The CHO configuration information for the timer-based event can include multiple information elements such as t1 threshold time and the duration. T1 threshold time expresses the time point after which the UE (109) can enter into the potential target node (113). Further, the duration indicates the maximum amount of time up to which the UE (109) can switch to the potential target node (113). The t1 threshold and duration is represented in the form of Coordinated Universal Time (UTC) format. FIG. 1E illustrates an example scenario in which time-based event during conditional handover of the UE in the NTN, according to the prior art as disclosed herein. During the timer-based event as shown in FIG. 1E the Tx (131) represents the time at which the UE (109) receives the CHO configuration information. Further, the UE (109) continuously monitors the timer-based condition to be satisfied for the handover. The UE (109) can move to the potential target node (113) at the time t1 threshold (133) as indicated in CHO configuration information. The t1 threshold indicates the entry point of the UE (109) to the potential target node (113). Further, the maximum time up to which the UE (109) can move to potential target node (113) is provided in “duration” of the CHO configuration information. Thus, the UE (109) can move to potential target node maximum up to time (t1+threshold) (137). Also, a time interval (135) represents the time in which the timer-based event is satisfied for the UE (109). Furthermore, upon the timer-based condition being satisfied, at step S4, the UE (109) sends the CHO confirmation to the potential target node (113). Eventually, the UE (109) performs context release and switches the path to the potential target node (113).

In traditional methods, FIG. 1F depicts an example scenario of timer-based and signal measurements-based events during a CHO of the User Equipment (UE) in NTN), as disclosed herein. As illustrated in FIG. 1F, let us consider a scenario where the UE (109) is currently served by NTN cell A (143). Further, the UE (109) receives CHO configuration information for NTN cell B (145) and NTN cell C (147) at time T1, which are referred to as target candidate cells. The CHO configuration information comprises a signal measurement-based event and a timer-based event. Upon receiving the CHO configuration information, the UE (109) initiates the signal measurements (151) and timer measurements (149) of NTN cell B (145) and NTN cell C (147).

During timer measurements (149), the UE (109) compares the current time with the t1 threshold indicated in the CHO configuration information. Similarly, during signal measurements (151), the UE (109) measures the signal strength of NTN cell B (145) and NTN cell C (147) to evaluate the signal conditions associated with the CHO configuration information. Until time Tx, the UE (109) remains under the coverage of NTN cell A (143). At time Tx, the UE (109) configures the CHO configuration information of NTN cell B (145) based on the t1 threshold and duration indicated in the CHO configuration information of NTN cell B (145). At time Tx+n, NTN cell B (145) starts serving the UE (109), and the timer-based event gets satisfied. Simultaneously, the signal measurements-based event is also satisfied. Once both the signal measurements-based event and timer-based event are satisfied, the UE (109) performs a handover to NTN cell B (145).

Hence, the UE (109) simultaneously performs both timer measurements (149) and signal measurements (151) from the time (T1) the CHO configuration information is received. During monitoring, either both the timer-based event and signal measurements-based event conditions will be satisfied, or one of the timer-based event and signal measurements-based event conditions will not be satisfied. Both the events need to be satisfied to execute the conditional handover to the target node. In a scenario where the signal measurements-based event condition is satisfied, but not the timer-based event, the performed signal measurements (151) increase the power consumption, leading to unnecessary measurements in the UE (109). This existing technique leads to inefficient signal measurement and consumes more power in the UE (109), thus affecting the battery life of the UE (109). In various embodiments, the power consumption becomes worse when the UE (109) configures multiple candidate cells with a time-based event, as the UE (109) performs signal measurements of multiple candidate cells that yield no significant results.

FIG. 1G is a flow diagram that illustrates a method of conditional handover of the UE with a timer-based event, according to the prior art as disclosed herein. At the outset, at block 153, the UE (109) is assumed to be in a connected mode for 5G services and has received CHO configuration information. Further, at block 155, the CHO configuration information includes a timer-based event (condevent T1) and signal measurements-based event (A3/A4/A5) for one or more target candidate cells. These events indicate the conditions that must be met to move to one of the potential target nodes (113).

Upon receiving the CHO configuration information at block 157, the UE (109) performs signal measurements of one or more target candidate cells. At the same time, at block 159, the UE (109) performs time-based measurements of the one or more target candidate cells. Furthermore, at block 161, the UE (109) awaits the time-based event to be satisfied, even though the signal measurements are satisfied for one or more target candidate cells. In various embodiments, at block 163, the UE (109) awaits the signal measurements to be satisfied, even though the time-based event is satisfied for the one or more target candidate cells.

Further, at block 165, the UE (109) determines whether both the signal measurements-based event and time-based event are satisfied. Only when the conditions of both events are met, the UE (109) at block 167 selects one of the target candidate cells as the selected cell for the conditional reconfiguration execution. Furthermore, at block 169, the UE (109) applies the stored conditional RRC reconfiguration of the selected cell and successfully performs the handover.

However, in the existing technique, the UE (109) initiates signal measurements and timer measurements simultaneously as soon as the CHO reconfiguration is received from the network (as indicated in block 157 and block 159). As a result, the UE (109) consumes more power for performing parallel signal measurements and timer measurements of one or more target candidate cells without any optimization. This leads to poor battery performance of the UE (109).

FIG. 1H illustrates an example scenario of distance-based event and signal measurements-based event during a CHO of the stationary UE in NTN, according to the prior art as disclosed herein. In FIG. 1H, let us consider a scenario where the UE (141) is currently serving in the NTN cell A (143) and has received CHO configuration information for the NTN cell B (145) and NTN cell C (147) at time T1. These cells are referred to as target candidate cells and the CHO configuration information includes both signal measurements-based and distance-based events. On receiving this information, the UE (109) initiates distance and timer measurements for the NTN cell B (145) and NTN cell C (147).

During distance measurements, the UE (141) calculates its current location with reference to two reference locations and a threshold distance to evaluate the criteria for the distance-based event. Similarly, for signal measurements, the UE (141) measures the signal strength of both cells to evaluate the signal conditions associated with the CHO configuration information.

However, since the UE (141) is stationary in the NTN cell A (143) at T1, it cannot meet the conditions for the distance-based and signal measurements-based events. The handover can only occur after the expiry of the t-service timer, which indicates the amount of time for which the NTN cell A (143) serves the location of the UE (141).

Once the t-service time expires, the UE (141) can move to either the NTN cell B (145) or cell C (147), depending on their coverage areas. For instance, if the UE (141) is covered by the cell B after the t-service timer expires, it performs the handover procedure with the NTN cell B (145).

Therefore, even though the UE (141) performs signal and distance measurements upon receiving the CHO configuration information at time T1, these measurements are unnecessary when the UE (141) is stationary. This leads to unnecessary power consumption and reduces the battery life of the UE (141). In some cases, configuring multiple candidate cells with distance-based events can worsen the power consumption as the UE (141) performs signal and distance measurements for all the candidate cells, yielding no significant results.

FIG. 1I illustrates an example scenario of distance-based event and signal measurements-based event during a CHO of UE under mobility state in NTN, according to the prior art as disclosed herein. The illustration in FIG. 1 depicts a scenario where a UE (141) is being served by the NTN cell A (143). At time T1, the UE (141) receives CHO configuration information for NTN cell B (145) and NTN cell C (147), which are considered target candidate cells. Notably, the NTN cell A (143) contains a satellite (171) that serves the UE (141), while NTN cell B (145) and NTN cell C (147) each contain a satellite (173) and (175), respectively.

The CHO configuration information contains both signal measurements-based and distance-based events. Upon receiving this information, the UE (141) initiates distance measurements (177) and timer measurements (149) for NTN cell B (145) and NTN cell C (147). In the distance measurements (177), the UE (141) calculates the distance between its current location and reference locations 1 and 2, as well as the threshold distance from these locations, to satisfy the evaluation criteria for the distance-based event. Reference location 1 refers to the satellite (171) in NTN cell A (143), while reference location 2 includes the location of at least one of the satellites (173) and (175).

Similarly, the UE (141) measures the signal strength of NTN cell B (145) and NTN cell C (147) in the signal measurements (151) to evaluate the signal conditions associated with the CHO configuration information. Currently, the UE (109) is being served by NTN cell A (143), which is at a distance D1 from reference location 1. Suppose the UE (141) is in motion and has reached a distance Dx from reference location 1. In that case, the UE (141) remains within the coverage area of both NTN cell A (143) and NTN cell B (145). However, when the UE (109) reaches a distance (D1+m) from reference location 1, it loses coverage from NTN cell A (143) and enters the coverage area of NTN cell B (145). At this point, the distance-based event for NTN cell B (145) is satisfied, and the UE (141) camps on NTN cell B (145).

Throughout the UE's (141) mobility, it performs distance measurements (177) and signal measurements (151) from the time it received the CHO configuration information. However, the distance-based event gets satisfied at distance Dx from reference location 1, leading to unnecessary signal measurements (151) being performed by the UE (141) even when the distance-based event is not satisfied for NTN cell B (145) or NTN cell C (147). This results in unnecessary power consumption and reduces the UE's (141) battery life. In some cases, configuring multiple candidate cells with distance-based events can worsen power consumption, as the UE (141) performs signal and distance measurements for multiple candidate cells that yield no significant results.

FIG. 1J is a flowchart illustrating a method of conditional handover of the mobile UE with a distance-based event, according to the prior art. At the outset, at block 181, it is assumed that the UE (109) is connected to 5G services and has received a CHO configuration information. Further, at block 182, the CHO configuration information comprises a distance-based event (condevent D1) and signal measurements-based event (A3/A4/A5) for one or more target candidate cells. These events indicate the conditions that need to be met for the UE (109) to move to one of the potential target candidate NTN cells. Upon receiving the CHO configuration information, the UE (109) performs signal measurements and distance-based measurements of one or more target candidate cells simultaneously, as indicated in blocks 183 and 184, respectively.

Furthermore, in various embodiments, the UE (109) waits for the distance-based event to be satisfied, even though the signal measurements are satisfied for one or more target candidate cells, as indicated in block 185. Similarly, in various embodiments, the UE (109) waits for signal measurements to be satisfied, even though the distance-based event is satisfied for the one or more target candidate cells, as indicated in block 186. Once both the signal measurements-based event and distance-based event conditions are met, as determined in block 187, the UE (109) selects one of the target candidate cells as the selected cell for the conditional reconfiguration execution, as indicated in block 188. Furthermore, at block 189, the UE (109) applies the stored condRRC reconfiguration of the selected cell and performs a successful handover.

However, the existing technique of performing parallel signal and distance measurements of one or more target candidate cells without optimization, as indicated in blocks 183 and 184, leads to poor battery performance of the UE (109) as it consumes more power.

FIG. 1K is a diagram illustrating an example scenario of distance-based event and signal measurements-based event during a measurement event of UE in NTN, according to the prior art. In an embodiment, the UE (141) is capable of measuring one or more target candidate cells, not only during conditional handover but also during the signal and distance measurements (151) and (177) of neighboring cells. These essential measurements, referred to as a measurement event, allow the UE (141) to transmit a measurement report to the network regarding the neighboring cells. For instance, during a measurement event, the UE (141) may start serving in NTN cell A (143) at the start of t-service time and measure the signal and distance of neighboring NTN cell B (145) and NTN cell C once measurement event gets configured (147). However, the UE (141) may perform these measurements independently, without checking the mobility state, from the start of t-service time till the end of t-service time. During distance measurements, the UE (141) calculates its current location with reference to location 1 and threshold distance to meet the evaluation criteria for distance-based event. Similarly, during signal measurements, the UE (141) measures the signal strength of neighboring cells to evaluate signal conditions for the measurement report. Although the UE (141) receives uniform signal strength across the coverage of the NTN cell due to the NTN deployment nature, performing signal measurements from the start of t-service time until the end of t-service time leads to wastage of resources, consumes more power, and degrades battery life. Similarly, when the UE (141) is in a stationary state, performing distance measurements leads to unnecessary wastage of resources, consumes more power, and degrades the battery life of the UE (141).

FIG. 1I is a flowchart illustrating a method of performing signal measurement and distance measurements of neighbor NTN cells, according to the prior art. At block 191, the UE (109) is initially assumed to be in connected mode for 5G services and is bestowed with a Radio Resource Control (RRC) configuration that includes measurement events. At block 192, the RRC configuration comprises a distance-based event (condevent D1) and signal measurements-based event (A1-A6) for one or more neighboring cells. Upon receipt of the RRC configuration at block 193, the UE (109) conducts signal measurements of one or more neighboring cells. Concurrently, at block 194, the UE (109) performs distance-based measurements of the same neighboring cells. Additionally, at block 195, the UE (109) awaits the satisfaction of the distance-based event, even if the signal measurements are satisfied for one or more neighboring cells. In various embodiments, at block 196, the UE (109) awaits the satisfaction of signal measurements, even if the distance-based event is satisfied for one or more neighboring cells. At block 197, the UE (109) determines whether the entry conditions of both the signal measurements-based event and distance-based event are satisfied. Once the conditions of both events are satisfied, at block 198, the UE (109) selects one of the neighboring cells as the selected cell for the conditional reconfiguration execution. Furthermore, at block 199, the UE (109) applies the stored condRRC reconfiguration of the selected cell and successfully performs a handover. In the existing technique, the UE (109) initiates both signal and distance measurements simultaneously upon receiving the RRC reconfiguration from the network (as indicated in block 193 and block 194). Due to the simultaneous measurement, the UE (109) consumes more power to perform parallel signal and distance measurements of one or more neighboring cells without any optimization, leading to poor battery performance of the UE (109).

Thus, there is a need to handle the conditional handover process in the NTN and also improve the resource utilization during a conditional handover process in the NTN.

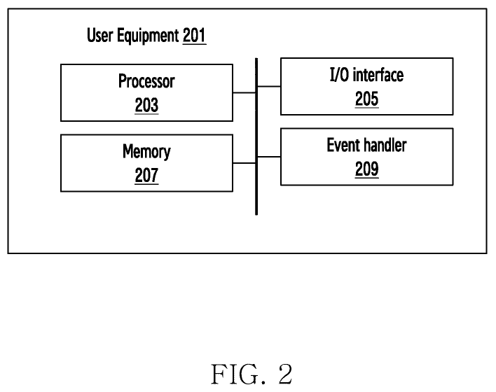

FIG. 2 is a block diagram illustrating an example configuration of user equipment for handling conditional handover in NTN, according to various embodiments. The User Equipment (UE) (201) includes a processor (e.g., including processing circuitry) (203), a memory (207), and an I/O interface (e.g., including circuitry) (205) and an event handler (e.g., including various circuitry) (209). The UE (201) can be an end-user device that connects with a communication network to access services. For example, the UE (201) can include, but not limited to a mobile phone, a smart phone, tablets, laptops, Internet of Things (IoT) devices. Further, the processor (203) of the UE (201) communicates with the memory (207), the I/O interface (205) and the event handler (209). The processor (203) is configured to execute instructions stored in the memory (207) and to perform various processes. The processor (203) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The processor (203) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Further, the memory (207) of the UE (201) includes storage locations to be addressable through the processor (203). The memory (207) is not limited to a volatile memory and/or a non-volatile memory. Further, the memory (207) can include one or more computer-readable storage media. The memory (207) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (207) can store the media streams such as audios stream, video streams, haptic feedbacks and the like.

The I/O interface (205) may include various circuitry and transmits the information between the memory (207) and external peripheral devices. The peripheral devices are the input-output devices associated with the UE (201). The I/O interface (205) receives several information from serving cell and neighboring cells of the UE (201) in the communication network. The several information received from plurality of UEs (201) can include but not limited to the Conditional Handover configuration information, and Radio Resource Control (RRC) configuration information.

The event handler (209) is an innovative hardware that is realized through the physical implementation of both analog and digital circuits, including logic gates, integrated circuits, microprocessors, microcontrollers, memory circuits, passive and active electronic components, as well as optical components.

The event handler (209) communicates with the I/O interface (205) and memory (207) for handling CHO in NTN. The event handler (209) of the UE (201) receives a CHO configuration information associated with one or more target candidate cells. The CHO configuration information can include, but not limited to a signal measurements-based event, timer-based event and distance-based event. Further, the event handler (209) starts one of the timer-based event or the distance-based event associated with one or more target candidate cells at a first-time instance. The first time instance is an instance at which the CHO configuration information is received. The timer-based event, distance-based event and signal measurements-based event indicates an evaluation criterion to perform a conditional handover of the UE (201) from a serving cell to a target candidate cell of the one or more target candidate cells. Thereafter, the UE (201) determines whether one of the timer-based event or distance-based event is completed. The UE (201) determines the completion of the distance-based event or timer-based event when the evaluation criterion is determined to be met/satisfied for the more target candidate cells. Eventually, upon the completion of the timer-based event or distance-based event the UE (201) performs the signal measurements-based event associated with the one or more target candidate cells at a second time instance. The second time instance is an instance at which the signa measurements-based event is performed. The second time instance is always ahead of the first-time instance.

In the disclosure, the UE (201) determines either a timer-based event or a distance-based event based on the CHO configuration information received. After successfully completing the distance-based event or timer-based event, the UE (201) determines the signal measurements-based event at the second instance. Since signal variations are minimal in the NTN, the signal measurements-based event is always met. Consequently, the UE (201) determines the signal measurements-based event only after completing either the timer-based event or distance-based event, thus avoiding unnecessary measurements of one or more target candidate cells. This results in reduced resource consumption during conditional handover and also reduces the power consumption of the UE (201).

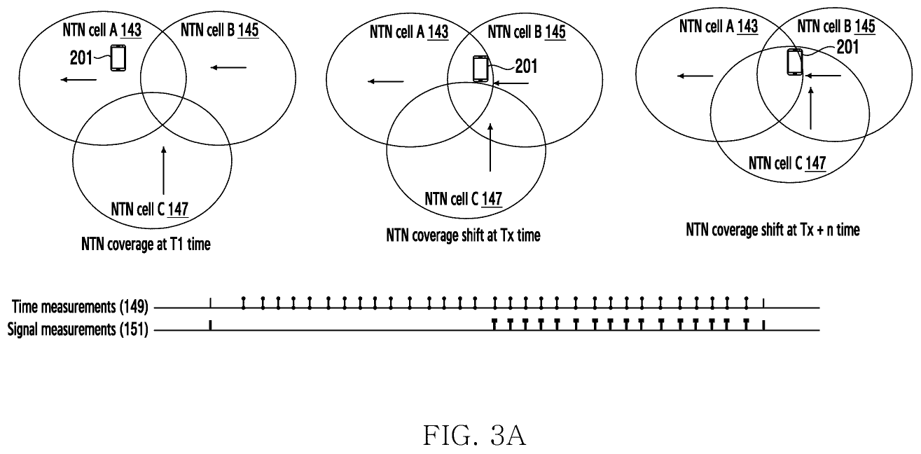

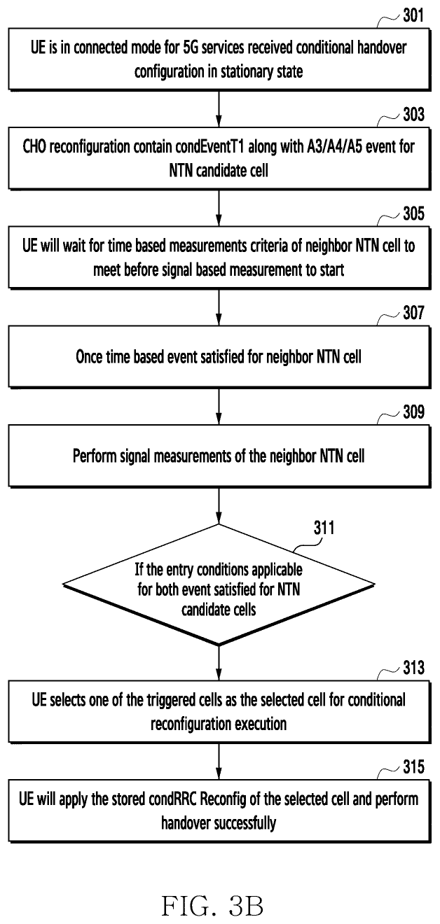

FIG. 3A is a diagram illustrating an example scenario in which the conditional handover of UE is managed through a timer-based event, according to various embodiments. As illustrated in FIG. 3A, the UE (201) currently serving in NTN cell A (143) receives a CHO configuration information at time T1, pertaining to target candidate NTN cell B (145) and target candidate NTN cell C (147). This information includes a signal measurements-based event and timer-based event, which indicate the evaluation criteria for a conditional handover of the UE (201) from the serving NTN cell A (143) to either target candidate NTN cell B (145) or target candidate NTN cell C (147).

The evaluation criteria for both signal measurement-based and timer-based events are defined for each target candidate NTN cell in the CHO configuration information. For example, the evaluation criteria defined for the timer-based event involves the UE (201) comparing the current time T1 with a configured threshold time Tx for a target candidate cell. If the current time is equal to or greater than the threshold time Tx, the UE (201) determines that the timer-based event is met for the target candidate cell. The UE (201) then evaluates whether the criteria for the timer-based event is met by the timer measurements (149) with respect to the threshold time Tx.

Upon successful completion of the timer-based event at time Tx, the UE (201) initiates the signal measurements-based event for the target candidate cell B (145) at the same time. This ensures that the UE (201) performs signal measurements (151) of the target candidate NTN cell B (145) when necessary, avoiding unnecessary signal measurements from both target candidate NTN cell B (145) and target candidate NTN cell C (147). This, in turn, minimizes and/or reduces resource utilization and reduces the power consumption of the UE (201).

Furthermore, upon successful completion of both the timer-based and signal measurement-based events, the UE (201) performs a handover to the target candidate NTN cell B (145) at time Tx+n, where n refers to the amount of time taken for the signal measurements-based event to be satisfied.

FIG. 3B is a flowchart illustrating an example method of handling conditional handover of UE with a timer-based event, according to various embodiments. At block 301, the UE (201) enters connected mode for 5G service and receives CHO configuration information. At block 302, the UE (201) reads the CHO information, which includes signal measurements-based and timer-based events for one or more target candidate NTN cells. Following the reception of the CHO configuration information at block 305, the UE (201) waits for the timer-based event to be completed for the one or more target candidate NTN cells before initiating the signal measurements-based event.

Further, at block 307, the UE (201) determines if the timer-based event is completed for the one or more target candidate NTN cells. The timer-based event is considered complete when the UE (201) meets the evaluation criteria associated with one or more target candidate NTN cells. Once the timer-based event is completed at block 309, the UE (201) performs signal measurements of the one or more target candidate NTN cell for which the timer-based event is completed.

At block 311, the UE (201) determines whether the criteria for both the signal measurements-based event and timer-based event of one or more target candidate NTN cells are satisfied. Further, at block 313, the UE (201) selects one of the target candidate NTN cells that has triggered the completion of both the signal measurements-based event and timer-based event. Furthermore, at block 315, the UE (201) applies conditional RRC reconfiguration of the selected target candidate NTN cell and performs a successful handover.

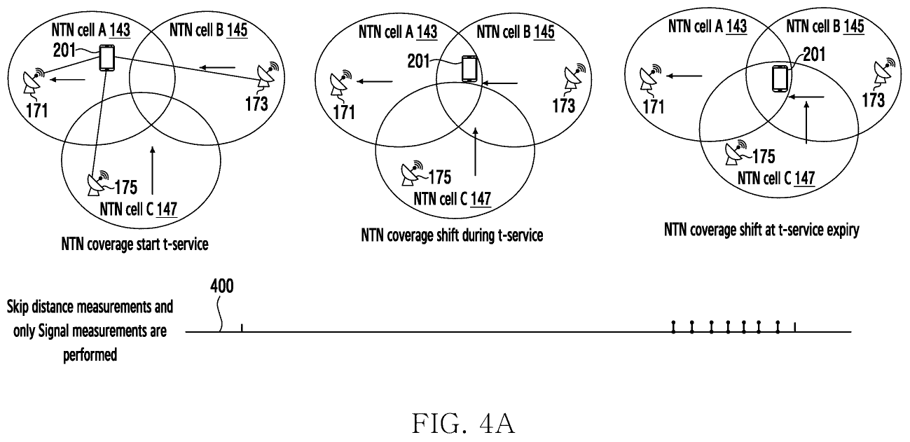

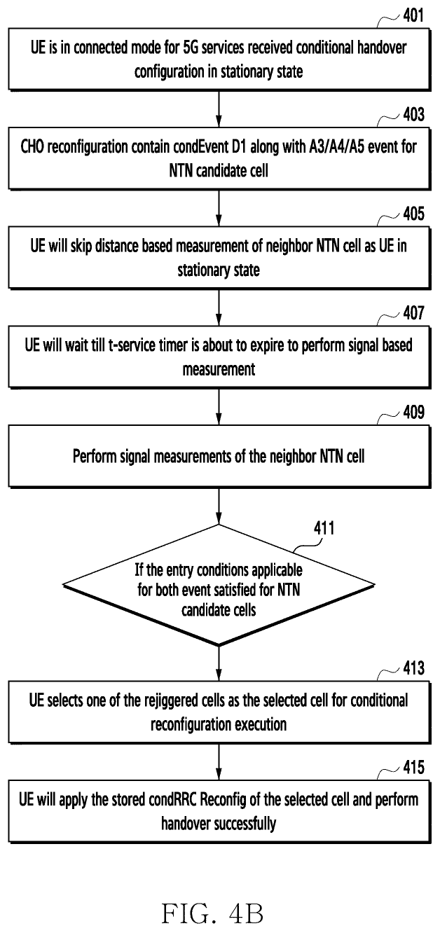

FIG. 4A is a diagram illustrating an example scenario in which the conditional handover of a stationary UE is managed through a distance-based event, according to various embodiments. FIG. 4A illustrates the scenario where the UE (201) is currently being served in NTN cell A (143) at the beginning of the t-service time. At this point, the UE receives CHO configuration information related to target candidate NTN cell B (145) and target candidate NTN cell C (147). The CHO configuration information comprises a signal measurements-based event and a distance-based event, which serve as evaluation criteria for a conditional handover of the UE from the serving NTN cell A to either the target candidate NTN cell B or the target candidate NTN cell C.

The CHO configuration information defines the evaluation criteria for the signal measurement-based event and distance-based event for each of the target candidate NTN cell B and the target candidate cell C. Before initiating the distance-based event and signal measurements-based event, the UE determines its mobility state. If the UE is stationary, it skips the distance measurements as it will continue to be served by the NTN cell A until the t-service time expires.

When the t-service time is about to expire, the UE performs signal measurements of the target candidate NTN cell B and target candidate NTN cell C. Upon successful completion of the signal measurement-based event, the UE performs a handover from the serving NTN cell A to the target candidate NTN cell B, resulting in a reduction of resource consumption and enhanced battery life of the UE.

Hence, the disclosure allows the UE to evaluate its mobility state and decide on the necessary actions to be taken based on this determination. When the UE is stationary, it avoids unnecessary signal measurements, thus conserving resources and prolonging battery life.

FIG. 4B is a flowchart illustrating an example method of handling conditional handover of stationary UE with a distance-based event, according to various embodiments. At block 401, the UE (201) is in connected mode for 5G service and also receives CHO configuration information from the serving cell in a stationary state. Further, at block 403, the UE (201) reads the CHO configuration information received, that includes the signal measurements-based event and the distance-based event for one or more target candidate NTN cells. Upon receiving the CHO configuration information, at block 405, the UE (201) will skip distance-based measurements of one or more target candidate NTN cells as the UE (201) in stationary state. Furthermore, at block 407, the UE (201) waits until the t-service times about to expire to perform the signal measurements. Thereafter, at block 409, the UE (201) performs the signal measurements of the one or more target candidate NTN cells when the t-service time of the serving cell A (143) is about to expire. Moreover, at block 411, the UE (201) determines whether an evaluation criteria for both the signal measurements-based event and distance-based event of one or more target candidate NTN cell is satisfied. Furthermore, at block 413, the UE (201) selects one among the one or more target candidate NTN cells that has triggered the completion of both the signal measurements-based event and distance-based event. Further, at block 415, the UE (201) applies the conditional RRC reconfiguration of the selected target candidate NTN cell and performs the successful handover with the selected target candidate NTN cell.

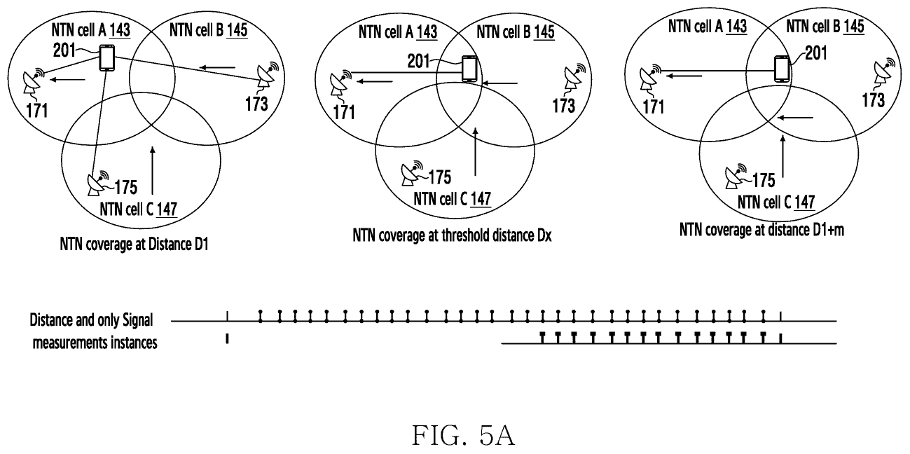

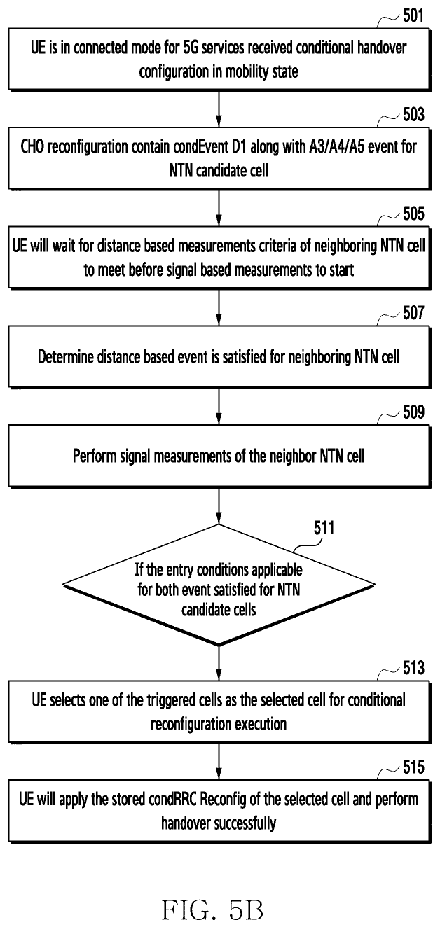

FIG. 5A is a diagram illustrating an example scenario in which conditional handover of a mobile UE is managed through a distance-based event, according to various embodiments. As shown in FIG. 5A, for example, consider a scenario of conditional handover of the UE (201). The UE (201) is serving in the NTN cell A (143) and the satellite (171) is providing signals to the UE (201). Also, the UE (201) is at a distance D1 from the reference location 1 of the NTN cell A (143). Further, the UE (201) receives a CHO configuration information from the target candidate NTN cell B (145) and target candidate NTN cell C (147). The CHO configuration information received from the target candidate NTN cell B (145) includes the distance-based event and the signal measurements-based event associated with NTN cell B (145). The distance-based event of NTN cell B (145) defines the distance-based entry conditions to be satisfied for serving in the target candidate cell B (145). Also, the signal measurements-based event defines the signal conditions to be satisfied for serving in target candidate NTN cell B (145). Similarly, the CHO configuration information received from the target candidate cell C (147) includes the distance-based event and signal measurements-based event associated with the NTN cell C (147). The distance-based event of NTN cell C (147) defines the distance-based entry conditions to be satisfied for serving in the target candidate cell C (147). Also, the signal measurements-based event defines the signal conditions to be satisfied for serving in the target candidate NTN cell C (147).

Upon receipt of the CHO information, the UE (201) commences distance-based measurements exclusively for the target candidate NTN cell B (145) and the target candidate NTN cell C (147). During these measurements, the UE (201) assesses whether the distance-based entry conditions are met for either of the target candidate NTN cells. The entry conditions are the conditions that needs to be satisfied for performing the conditional handover. For example, the UE (201) computes its current location relative to the reference location 1 and reference location 2. The former corresponds to serving NTN cell A (143), while the latter pertains to target candidate NTN cell B (145). Furthermore, the UE's distance is compared against threshold distance 1 and threshold distance 2 to determine whether the entry conditions are satisfied for at least one of the target candidate NTN cells. The former is the maximum distance within which the satellite (171) can cater to the UE (201) in serving NTN cell A (143), while the latter is the maximum distance within which the satellite (173) can attend to the UE (201) in target candidate cell B (145).

Assuming that the UE (201) is located at distance D1 from reference location 1, and given the UE's mobility at time Tx, it is situated at distance Dx from the same reference location. At distance Dx, the UE (201) is deemed to be within the threshold distance 2 from the reference location 2 associated with target candidate NTN cell B (145). Hence, during the evaluation at distance Dx, the UE (201) is established to fulfill the distance-based entry condition of target candidate NTN cell B (145).

Once the distance-based entry conditions is satisfied, the UE (201) when at distance Dx, initiates the signal measurements from the target candidate NTN cell B (145). Furthermore, when the signal measurement conditions are satisfied for the target candidate cell B (145), the UE (201) performs the successful handover with the target candidate cell B (145) when the UE moves a m distance that such that D1+m is reaching the threshold distance 1. Eventually, the UE (201) will serve in the target NTN cell B (145) upon the successful handover.

FIG. 5B is a flowchart illustrating an example method of handling conditional handover of mobile UE with a distance-based event, according to various embodiments. At the outset, at block 501, the UE (201) is connected to 5G service and simultaneously receives the CHO configuration information while in a mobility state. The UE (201) then reads the CHO configuration information, which includes signal measurements-based events (A3/A4/A5) and distance-based events (condEvent D1) for one or more target candidate NTN cells, at block 503. Upon receiving the CHO configuration information, the UE (201) initiates distance-based measurements of one or more target candidate NTN cells while in a mobility state, as described at block 505. The UE (201) then waits until the distance-based entry conditions are met for one of the target candidate cells.

At block 507, the UE (201) determines whether the distance-based event has been satisfied for one or more target candidate cells. If so, at block 509, the UE (201) performs signal measurements of the target candidate NTN cells. At block 511, the UE (201) determines whether the evaluation criteria for both the signal measurements-based event and distance-based event of one or more target candidate NTN cells are satisfied. If so, at block 513, the UE (201) selects one of the target candidate NTN cells that has triggered the completion of both the signal measurements-based event and the distance-based event. Furthermore, at block 515, the UE (201) applies conditional RRC reconfiguration to the selected target candidate NTN cell and performs a successful handover.

Hence, while in a mobility state, the UE (201) performs only distance measurements until the distance-based event is satisfied for one of the target candidate NTN cells. After the completion of the distance-based event does the UE (201) perform the signal measurements-based event, as described in the disclosure. This approach prevents/reduces unnecessary signal measurements and reduces power consumption, resulting in longer battery life for the UE (201).

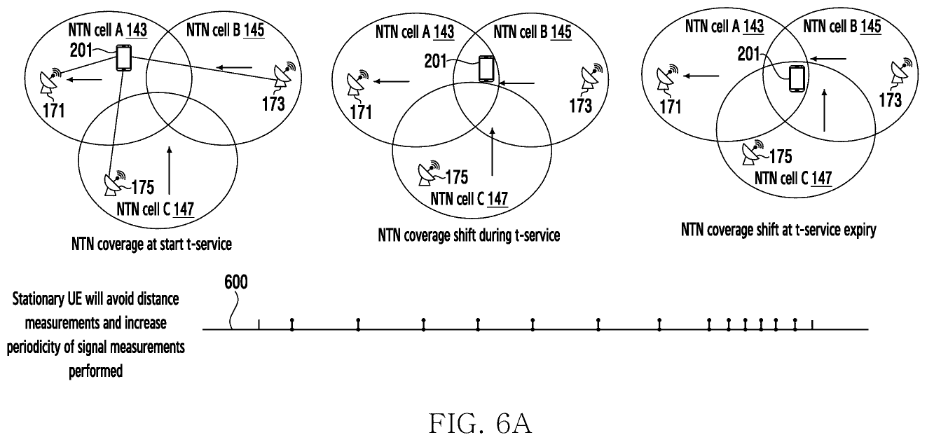

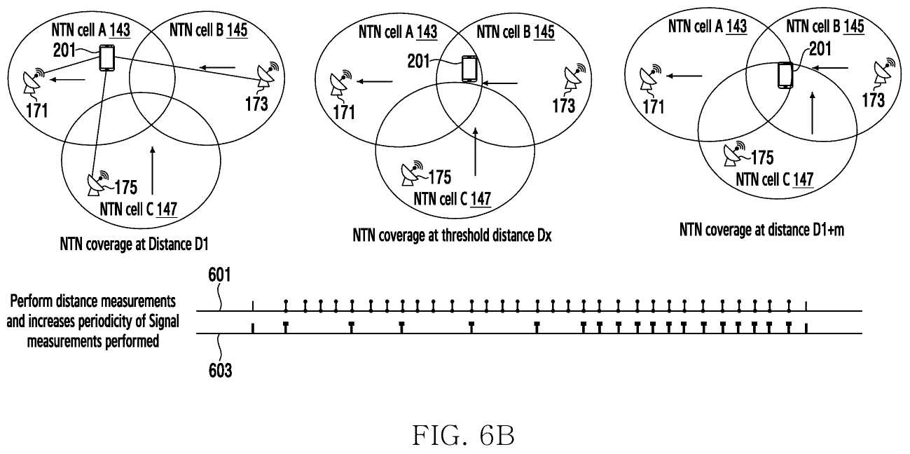

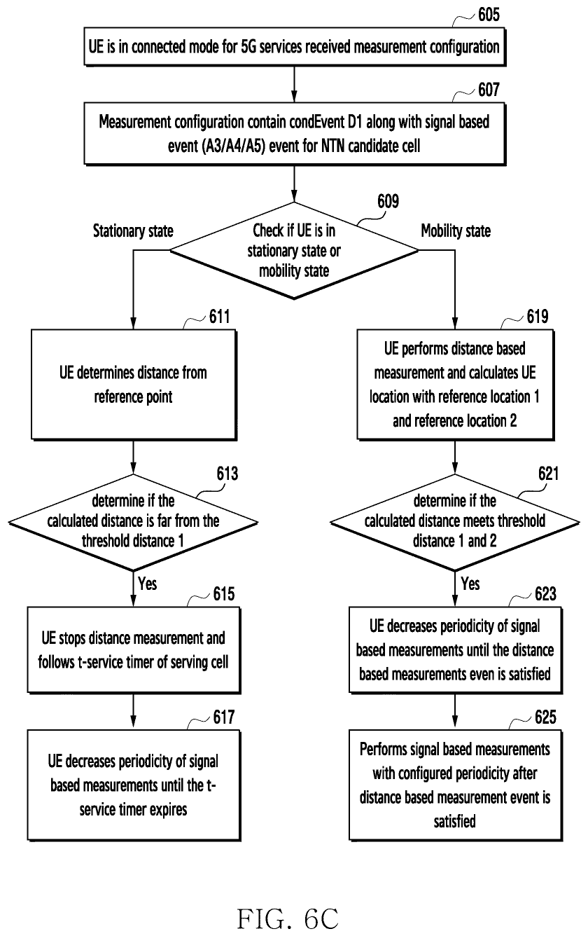

FIG. 6A is a diagram illustrating an example scenario in which the measurement configuration of a stationary UE is managed through a distance-based event, according to various embodiments. Referring to FIG. 6A, consider a scenario where a User Equipment (UE) (201) is engaged in a measurement event. The UE (201) is being served by NTN cell A (143). At the start of the t-service time, the UE (201) receives a measurement event pertaining to target candidate NTN cell B (145) and target candidate NTN cell C (147). The measurement event comprises of signal measurements-based event and distance-based event. Before initiating these events, the UE (201) determines its mobility state. If the UE (201) is stationary, it skips the distance measurements (400) as it will continue to be served by NTN cell A (143) until the t-service time expires. At the beginning and mid-point of the t-service time, the UE (201) performs signal measurements (600) with a high time period gap. As the t-service time approaches expiry, the UE (201) performs signal measurements (600) with a lesser time period gap. Based on the signal measurements (600) performed for target candidate NTN cell B (145) and target candidate cell C (147), the UE (201) provides a measurement report to serving NTN cell A (143). Once the t-service time expires and the signal measurements (600) are satisfactory, the UE (201) performs a handover from serving cell A (143) to target candidate NTN cell B (145) based on the measurement report. Notably, when the UE (201) is stationary, distance measurements with respect to one or more target candidate NTN cells are skipped. The UE (201) performs signal measurements (600) of the target candidate NTN cells only when the t-service time expires. This disclosure may prevent/reduce unnecessary signal measurements when the UE (201) is being served with good signal conditions under the current serving NTN cell A (143) until the expiry of the t-service time. Consequently, this reduces resource consumption and enhances the battery life of the UE (201).

FIG. 6B is a diagram illustrating an example scenario in which measurement configuration of a mobile UE is managed through a distance-based event, according to various embodiments. In FIG. 6B, let us consider a scenario where the UE (201) is engaged in a measurement event. The UE (201) is being served by NTN cell A (143) and at the start of the t-service time, it receives a measurement event associated with the target candidate NTN cell B (145) and the target candidate NTN cell C (147). This measurement event comprises of a signal measurements-based event and a distance-based event. Before initiating these events, the UE (201) determines its mobility state. If it is determined to be mobility state, the UE (201) continuously monitors the distance covered with respect to the threshold distance 1 of the serving NTN cell A (143). Additionally, the periodicity of the signal measurements (603) of the target candidate NTN cell B (145) and the target candidate NTN cell C (147) is reduced when the location of the UE (201) is not near to the threshold distance Dx. On the other hand, the periodicity of the signal measurements (603) is increased when the location of the UE (201) with respect to the reference location 1 is near to the distance threshold Dx. Once both the distance measurements (601) and the signal measurements (603) meet the evaluation criteria as per the measurement report, the UE (201) performs a handover from serving cell A (143) to the target candidate NTN cell B (145). In particular, when the UE (201) is in a mobility state, distance measurements (601) are performed continuously, and signal measurements (603) are performed periodically based on the threshold distance and reference location of the UE (201). The disclosure effectively measures the signal measurements-based event based on the distance variation of the UE (201) during mobility. This is because signal strength does not change significantly in UE (201) when the distance on mobility does not change significantly. As a result, the disclosure may prevent/reduce unnecessary signal measurements, saves power consumption of the UE (201), and enhances the battery life of the UE (201).

FIG. 6C is a flowchart illustrating an example method of handling measurement configuration with a distance-based event, according to various embodiments. At block 605, the UE (201) is in connected for 5G services and receives a measurement configuration by the network. At block 607, the UE (201) retrieves the measurement configuration, which includes distance-based and signal measurements-based events for one or more target candidate NTN cells. At block 609, the UE (201) determines if the UE (201) is in its stationary state or mobility state. When the UE (201) is determined to be in stationary state, then at block 611, the UE (201) determines the distance from reference point. Further, at block 613, the UE determined whether the calculated distance is far from the threshold distance 1. Further, when the calculated distance is determined to be far from the threshold distance 1, then at block 615, the UE (201) stops distance measurement and follows t-service timer of serving cell. Further, at block 617, the UE decrease the periodicity of the signal measurements-based event until the t-service timer expires. However, at block 609, when the UE (201) is determined to be mobile, at block 619 the UE (201) performs distance based measurement and calculates UE location with reference location 1 and reference location 2. Further at block 621, the UE (201) determines whether the calculated distance meets the threshold distance 1 and threshold distance 2. Further, at block 623, the UE decreases the periodicity of the signal measurements until the distance measurements-based event is satisfied. Further, at block 625, the UE (201) performs signal measurements with configured periodicity after distance measurements-based event is satisfied.

The various actions, acts, blocks, steps, or the like in the method is performed in the order presented, in a different order or simultaneously. Further, in various embodiments, some of the actions, acts, blocks, steps, or the like are omitted, added, modified, skipped, or the like without departing from the scope of the disclosed method.

The disclosure empowers the UE to specify the timing and frequency for conducting signal measurements on neighboring NTN cells during connected mode mobility. This is achieved by utilizing both distance-based and time-based event conditions associated with a particular neighboring NTN cell. By factoring in the t-service timer of the serving NTN cell and the UE's mobility state, the disclosure determines the optimal timing and periodicity for conducting signal measurements of the neighboring NTN cell in connected mode.

The disclosure possesses considerable technical merit, particularly, among other things, in the context of Release-17 NTN. The disclosure determines the appropriate timing and frequency of signal measurements on neighboring NTN cells, taking into account various factors such as distance and time conditions, as well as the mobility state of the UE and the serving cell's t-service timer.

The 3GPP specifications have delegated to UE implementation the responsibility of evaluating the time- or location-based trigger condition in conjunction with the RRM measurement-based event (A3/A4/A5) when the UE is in Connected Mode in an NTN cell. Ordinarily, the UE is expected to commence evaluating the measurement conditions as soon as it receives the Conditional HO configuration from the network. This disclosure provides UE implementation, whereby the UE can “reduce” the measurements and/or the “frequency” of the measurements related to CHO HO, taking into account the inherent characteristics of the NTN cell and optimizing it further by considering the mobility condition of the UE (static or mobile). The disclosure leads to a reduction in measurements and thus power savings for the NTN UE.

The disclosure prevents/reduces superfluous signal measurements of adjacent NTN cells in connected mode, thereby minimizing/reducing power consumption by the UE. The prior art does not address the timing of signal-based measurement events for CHO based on time or distance-based events. Therefore, the disclosure is distinct. The disclosure has the potential to prevent/reduce superfluous signal measurements while maintaining seamless handover execution in connected mode NTN mobility. This helps in achieving consistent service continuity in NTN while reducing power consumption.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

According to embodiments, a method for handling conditional handover of a User Equipment (UE) in Non-Terrestrial Network (NTN) comprises receiving, by a UE, Conditional Handover (CHO) configuration information associated with one or more target candidate cells, wherein the CHO configuration information includes a signal measurements-based event and one of a timer-based event or a distance-based event. The method may comprise starting, by the UE, one of the timer-based event or the distance-based event associated with the one or more target candidate cell at a first-time instance. The method may comprise determining, by the UE, whether one of the timer-based event or the distance-based event is completed. The method may comprise performing, by the UE, the signal-measurements-based event associated with the one or more target candidate cell at a second time instance, based on one of the time-based event or the distance-based event being completed.

In an embodiment, the method may comprise determining, by the UE, whether an entry condition for the signal measurements-based event and one of the timer-based event or the distance-based event is completed. The method may comprise performing, by the UE, one of a CHO procedure from a source cell to a selected target candidate cell of the one or more target candidate cells, based on the entry condition for the signal measurements-based event and one of the timer-based event or the distance-based event being completed, or measurement configuration from a source cell to a selected target candidate cell of the one or more target candidate cells, based on the entry condition for the signal measurements-based event and the distance-based event being completed.

In an embodiment, wherein the CHO configuration information includes the timer-based event when the UE is in connected mode for 5G services, wherein the CHO configuration information includes the distance-based event when the UE is in connected mode for 5G services and the UE is in at least one of a mobility state and a stationary state.

In an embodiment, wherein performing the signal measurements-based event at the second time instance comprises determining, by the UE, whether the UE is in one of a mobility state or a stationary state. wherein performing the signal measurements-based event at the second time instance comprises performing, by the UE, one of based on the UE being in the mobility state, determining the second instance and a periodicity of the signal-based measurement event for the one or more target candidate cells for the UE in the mobility state, and performing the signal-measurements-based event associated with the one or more target candidate cell at the second time instance based on the determined periodicity, or wherein based on the UE being in the stationary state, determining the second instance and a periodicity of the signal-based measurement event for the one or more target candidate cells for the UE in the stationary state, and performing the signal-measurements-based event associated with the one or more target candidate cell at the second time instance based on the determined periodicity.

In an embodiment, wherein determining, by the UE, whether the entry conditions for timer-based event is completed comprises comparing, by the UE, current time of the UE while performing timer-based event with a specified threshold time. Wherein determining, by the UE, whether the entry conditions for timer-based event is completed comprises determining, the completion of the timer-based event when the current time of the UE is greater than or equal to the specified threshold time.

In an embodiment, wherein determining whether the entry conditions for distance-based event is completed comprises determining, by the UE, distance between a current location of the UE with respect to a first reference location and second reference location. Wherein determining whether the entry conditions for distance-based event is completed comprises determining, by the UE, completion of the distance-based event based on at least one of the distance between the current location of the UE and first reference location being greater than a specified first threshold of the first reference location and distance between the current location of the UE and second reference point being shorter than preconfigured second threshold of the second reference location.

In an embodiment, wherein performing measurement configuration from a source cell to a selected target candidate cell of the one or more target candidate cells comprises determining, by the UE, whether the UE is in one of a mobility state or a stationary state. Wherein performing measurement configuration from a source cell to a selected target candidate cell of the one or more target candidate cells comprises performing one of based on the UE being in stationary state, skipping the distance-based event; and performing at least one of signal-measurements-based event with reduced periodicity until the t-service timer is about expire for the serving cell or performing the signal-measurements-based event with increased periodicity based on the t-service timer being about to expire, or based on the UE being in mobility state, performing the distance-based event continuously; and performing the signal-measurements-based event with reduced periodicity until the distance-based event is determined to be completed.

According to embodiments, A method for handling conditional handover of a User Equipment (UE) in Non-territorial network (NTN) may comprise receiving, by a UE, conditional handover (CHO) configuration information associated with one or more target candidate cells, wherein the CHO configuration information includes a signal measurements-based event and a distance-based event based on the UE being in a connected mode for 5G services and the UE being in a stationary state. The method may comprise skipping, by the UE, the distance-based event associated with the one or more target candidate cell at a first-time instance. The method may comprise determining, by the UE, whether a t-service timer meets a t-service timer expiry threshold. The method may comprise starting, by the UE, the signal-measurements-based event associated with the one or more target candidate cell at a second time instance, based on the t-service timer being about to expire.

In an embodiment, the method may comprise determining, by the UE, whether an entry condition for the signal measurements-based event and the distance-based event is completed. The method may comprise performing, by the UE, a CHO procedure from a source cell to a selected target candidate cell of the one or more target candidate cells based on the entry condition for the signal measurements-based event and the distance-based event being completed.

In an embodiment, wherein performing the signal measurements-based event at the second time instance comprises determining, by the UE, whether the UE is in one of a mobility state or a stationary state. Wherein performing the signal measurements-based event at the second time instance comprises performing, by the UE, one of based on the UE being in the mobility state, determining the second instance and a periodicity of the signal-based measurement event for the one or more target candidate cells for the UE in the mobility state, and performing the signal-measurements-based event associated with the one or more target candidate cell at the second time instance based on the determined periodicity, or based on the UE being in the stationary state, determining the second instance and a periodicity of the signal-based measurement event for the one or more target candidate cells for the UE in the stationary state, and performing the signal-measurements-based event associated with the one or more target candidate cell at the second time instance based on the determined periodicity.

In an embodiment, wherein determining, by the UE, whether the entry conditions for timer-based event is completed comprises comparing, by the UE, current time of the UE while performing timer-based event with a specified threshold time. Wherein determining, by the UE, whether the entry conditions for timer-based event is completed comprises determining, the completion of the timer-based event when the current time of the UE is greater than or equal to the specified threshold time.

According to embodiments, a User Equipment (UE) for handling conditional handover in Non-Terrestrial Network may comprise at least one processor comprising processing circuitry. The UE may comprise an event handler comprising circuitry, communicatively coupled to at least one processor. The event handler may be configured to receive Conditional Handover (CHO) configuration information associated with one or more target candidate cells, wherein the CHO configuration information includes a signal measurements-based event and one of a timer-based event or a distance-based event. The event handler may be configured to start one of the timer-based event or the distance-based event associated with the one or more target candidate cell at a first-time instance. The event handler may be configured to determine whether one of the timer-based event or the distance-based event is completed. The event handler may be configured to perform the signal-measurements-based event associated with the one or more target candidate cell at a second time instance, based on one of the time-based based event or the distance-based event being completed.

In an embodiment, wherein the event handler may be configured to determine whether an entry condition for the signal measurements-based event and one of the timer-based event or the distance-based event is completed. Wherein the event handler may be configured to perform one of a CHO procedure from a source cell to a selected target candidate cell of the one or more target candidate cells, based on the entry condition for the signal measurements-based event and one of the timer-based event or the distance-based event being completed. Wherein the event handler may be configured to perform measurement configuration from a source cell to a selected target candidate cell of the one or more target candidate cells, based on the entry condition for the signal measurements-based event and distance-based event being completed.

In an embodiment, wherein the CHO configuration information includes the timer-based event based on the UE being in a connected mode for 5G services, wherein the CHO configuration information includes the distance-based event based on the UE being in a connected mode for 5G services and the UE being in at least one of a mobility state and a stationary state.

In an embodiment, wherein to perform the signal measurements-based event at the second time instance the event handler may be configured to determine whether the UE is in one of a mobility state or a stationary state. The event handler may be configured to perform one of, based on the UE being in the mobility state, determine the second instance and a periodicity of the signal-based measurement event for the one or more target candidate cells for the UE in the mobility state, and perform the signal-measurements-based event associated with the one or more target candidate cell at the second time instance based on the determined periodicity, or based on the UE being in the stationary state, determine the second instance and a periodicity of the signal-based measurement event for the one or more target candidate cells for the UE in the stationary state, and perform the signal-measurements-based event associated with the one or more target candidate cell at the second time instance based on the determined periodicity.

In an embodiment, wherein to determine whether the entry conditions for timer-based event is completed the event handler may be configured to compare current time of the UE while performing timer-based event with a specified threshold time. Wherein to determine whether the entry conditions for timer-based event is completed the event handler may be configured to determine the completion of the timer-based event when the current time of the UE is greater than or equal to the specified threshold time.

In an embodiment, wherein to determine whether the entry conditions for distance-based event is completed the event handler may be configured to determine distance between a current location of the UE with respect to a first reference location and second reference location. Wherein to determine whether the entry conditions for distance-based event is completed the event handler may be configured to determine completion of the distance-based event when at least one of the distance between the current location of the UE and first reference location becomes greater than a specified first threshold of the first reference location and distance between the current location of the UE and second reference point becomes shorter than a specified second threshold of the second reference location.

In an embodiment, wherein to perform measurement configuration from a source cell to a selected target candidate cell of the one or more target candidate cells the event handler may be configured to determine whether the UE is in one of a mobility state or a stationary state. Wherein to perform measurement configuration from a source cell to a selected target candidate cell of the one or more target candidate cells the event handler may be configured to based on the UE being in the stationary state, skipping the distance-based event; and performing at least one of signal-measurements-based event with reduced periodicity until the t-service timer is about expire for the serving cell or performing the signal-measurements-based event with increased periodicity when the t-service timer is about to expire, or based on the being in the mobility state, performing the distance-based event continuously; and performing the signal-measurements-based event with reduced periodicity until the distance-based event is determined to be completed.

According to embodiments, a UE for handling conditional handover of a User Equipment (UE) in Non-territorial network (NTN) may comprise at least one processor comprising processing circuitry. The UE may comprise an event handler comprising circuitry. Wherein the event handler may be configured to receive conditional handover (CHO) configuration information associated with one or more target candidate cells, wherein the CHO configuration information includes a signal measurements-based event and a distance-based event based on the UE being in a connected mode for 5G services and the UE being in a stationary state. Wherein the event handler may be configured to skip the distance-based event associated with the one or more target candidate cell at a first-time instance. Wherein the event handler may be configured to determine whether a t-service timer meets a t-service timer expiry threshold. Wherein the event handler may be configured to start the signal-measurements-based event associated with the one or more target candidate cell at a second time instance, based on the t-service timer meeting the t-service timer expiry.

In an embodiment, wherein the UE may be configured to determine whether an entry condition for the signal measurements-based event and the distance-based event is completed. The UE may be configured to perform a CHO procedure from a source cell to a selected target candidate cell of the one or more target candidate cells based on the entry condition for the signal measurements-based event and the distance-based event being completed.

In an embodiment, wherein to perform the signal measurements-based event at the second time instance the UE may be configured to determine whether the UE is in one of a mobility state or a stationary state. The UE may be configured to perform one of based on the UE being in the mobility state, determine the second instance and a periodicity of the signal-based measurement event for the one or more target candidate cells for the UE in the mobility state, and perform the signal-measurements-based event associated with the one or more target candidate cell at the second time instance based on the determined periodicity, or based on the UE being in the stationary state, determine the second instance and a periodicity of the signal-based measurement event for the one or more target candidate cells for the UE in the stationary state, and perform the signal-measurements-based event associated with the one or more target candidate cell at the second time instance based on the determined periodicity.

According to embodiments, a method may be performed by a user equipment (UE) for handling a conditional handover (CHO) in non-terrestrial network (NTN). The method may comprise receiving, by the UE, CHO configuration information associated with one or more target candidate cells, wherein the CHO configuration information includes a signal measurements-based event and one of a timer-based event or a distance-based event. The method may comprise starting, by the UE, a measurement for one of the timer-based event or the distance-based event associated with the one or more target candidate cells at a first time instance. The method may comprise determining, by the UE, whether the measurement for one of the timer-based event or the distance-based event is completed. The method may comprise performing, by the UE, a measurement for the signal measurements-based event associated with the one or more target candidate cells at a second time instance, in accordance with a determination that the measurement for one of the timer-based event or the distance-based event is completed.

In an embodiment, the method may comprise determining, by the UE, whether an entry condition for the signal measurements-based event and one of the timer-based event or the distance-based event is completed. The method may comprise performing, by the UE, one of a CHO procedure from a source cell to a selected target candidate cell of the one or more target candidate cells, based on the entry condition for the signal measurements-based event and one of the timer-based event or the distance-based event being completed, or measurement configuration from a source cell to a selected target candidate cell of the one or more target candidate cells, based on the entry condition for the signal measurements-based event and the distance-based event being completed.

In an embodiment, wherein the CHO configuration information includes the timer-based event when the UE is in connected mode for 5G services, wherein the CHO configuration information includes the distance-based event when the UE is in connected mode for 5G services and the UE is in at least one of a mobility state and a stationary state.

In an embodiment, wherein performing the measurement for the signal measurements-based event at the second time instance comprises determining, by the UE, whether the UE is in one of a mobility state or a stationary state. wherein performing the measurement for the signal measurements-based event at the second time instance comprises performing, by the UE, one of, based on the UE being in the mobility state, determining the second instance and a periodicity of the signal measurements-based event for the one or more target candidate cells for the UE in the mobility state, and performing the measurement for the signal measurements-based event associated with the one or more target candidate cells at the second time instance based on the determined periodicity, and based on the UE being in the stationary state, determining the second instance and a periodicity of the signal measurements-based event for the one or more target candidate cells for the UE in the stationary state, and performing the measurement for the signal measurements-based event associated with the one or more target candidate cells at the second time instance based on the determined periodicity.

In an embodiment, wherein determining, by the UE, whether entry conditions for the timer-based event is completed comprises comparing, by the UE, current time of the UE while performing the measurement for the timer-based event with a specified threshold time. wherein determining, by the UE, whether entry conditions for the timer-based event is completed comprises determining, the completion of the measurement for the timer-based event when the current time of the UE is greater than or equal to the specified threshold time.
wherein determining whether the measurement for the distance-based event is completed comprises determining, by the UE, distance between a current location of the UE with respect to a first reference location and second reference location, wherein determining whether the measurement for the distance-based event is completed comprises determining, by the UE, completion of the measurement for the distance-based event based on at least one of the distance between the current location of the UE and first reference location being greater than a specified first threshold of the first reference location and distance between the current location of the UE and second reference point being shorter than preconfigured second threshold of the second reference location.

In an embodiment, wherein performing the measurement configuration from the source cell to the selected target candidate cell of the one or more target candidate cells comprises determining, by the UE, whether the UE is in one of a mobility state or a stationary state. wherein performing the measurement configuration from the source cell to the selected target candidate cell of the one or more target candidate cells comprises performing one of based on the UE being in stationary state, skipping the measurement for the distance-based event; and performing at least one of the measurement for the signal measurements-based event with reduced periodicity until the t-service timer is about expire for the serving cell or performing the measurement for the signal measurements-based event with increased periodicity based on the t-service timer being about to expire, or based on the UE being in mobility state, performing the measurement for the distance-based event continuously; and performing the measurement for the signal measurements-based event with reduced periodicity until the measurement for the distance-based event is determined to be completed.

According to embodiments, a method may be performed by a user equipment (UE) for handling a conditional handover (CHO) in non-territorial network (NTN). The method may comprise receiving, by the UE, CHO configuration information associated with one or more target candidate cells, wherein the CHO configuration information includes a signal measurements-based event and a distance-based event based on the UE being in a connected mode for 5G services and the UE being in a stationary state. The method may comprise skipping, by the UE, a measurement for the distance-based event associated with the one or more target candidate cells at a first time instance. The method may comprise determining, by the UE, whether a t-service timer meets a t-service timer expiry threshold. The method may comprise starting, by the UE, a measurement for the signal measurements-based event associated with the one or more target candidate cells at a second time instance, in accordance with a determination that the t-service timer meets the t-service timer expiry threshold.

In an embodiment, the method may comprise determining, by the UE, whether an entry condition for the signal measurements-based event and the distance-based event is completed. The method may comprise performing, by the UE, a CHO procedure from a source cell to a selected target candidate cell of the one or more target candidate cells based on the entry condition for the signal measurements-based event and the distance-based event being completed.

In an embodiment, wherein performing the measurement for the signal measurements-based event at the second time instance comprises determining, by the UE, whether the UE is in one of a mobility state or a stationary state. wherein performing the measurement for the signal measurements-based event at the second time instance comprises performing, by the UE, one of based on the UE being in the mobility state, determining the second instance and a periodicity of the signal-based measurement event for the one or more target candidate cells for the UE in the mobility state, and performing the measurement for the signal measurements-based event associated with the one or more target candidate cells at the second time instance based on the determined periodicity, and based on the UE being in the stationary state, determining the second instance and a periodicity of the signal-based measurement event for the one or more target candidate cells for the UE in the stationary state, and performing the measurement for the signal measurements-based event associated with the one or more target candidate cells at the second time instance based on the determined periodicity.

According to embodiments, a user equipment (UE) for handling a conditional handover (CHO) in non-terrestrial network (NTN) may comprise at least one processor comprising processing circuitry. The UE may comprise memory, comprising one or more storage media, storing instructions. Wherein the instructions, when executed by the at least one processor individually or collectively, cause the UE to receive CHO configuration information associated with one or more target candidate cells, wherein the CHO configuration information includes a signal measurements-based event and one of a timer-based event or a distance-based event. Wherein the instructions, when executed by the at least one processor individually or collectively, cause the UE to start a measurement for one of the timer-based event or the distance-based event associated with the one or more target candidate cells at a first time instance. Wherein the instructions, when executed by the at least one processor individually or collectively, cause the UE to determine whether the measurement for one of the timer-based event or the distance-based event is completed. Wherein the instructions, when executed by the at least one processor individually or collectively, cause the UE to perform a measurement for the signal-measurements-based event associated with the one or more target candidate cells at a second time instance, in accordance with a determination that the measurement for one of the time-based based event or the distance-based event being completed.

In an embodiment, wherein the instructions, when executed by the at least one processor individually or collectively, cause the UE to determine whether an entry condition for the signal measurements-based event and one of the timer-based event or the distance-based event is completed. Wherein the instructions, when executed by the at least one processor individually or collectively, cause the UE to perform one of a CHO procedure from a source cell to a selected target candidate cell of the one or more target candidate cells, based on the entry condition for the signal measurements-based event and one of the timer-based event or the distance-based event being completed. Wherein the instructions, when executed by the at least one processor individually or collectively, cause the UE to perform measurement configuration from a source cell to a selected target candidate cell of the one or more target candidate cells, based on the entry condition for the signal measurements-based event and distance-based event being completed.

In an embodiment, wherein the CHO configuration information includes the timer-based event based on the UE being in a connected mode for 5G services, wherein the CHO configuration information includes the distance-based event based on the UE being in a connected mode for 5G services and the UE being in at least one of a mobility state and a stationary state.

In an embodiment, wherein, to perform the measurement for the signal measurements-based event at the second time instance, the instructions, when executed by the at least one processor individually or collectively, cause the UE to determine whether the UE is in one of a mobility state or a stationary state. Wherein, to perform the measurement for the signal measurements-based event at the second time instance, the instructions, when executed by the at least one processor individually or collectively, cause the UE to perform one of based on the UE being in the mobility state, determine the second instance and a periodicity of the signal measurements-based event for the one or more target candidate cells for the UE in the mobility state, and perform the measurement for the signal measurements-based event associated with the one or more target candidate cells at the second time instance based on the determined periodicity, and based on the UE being in the stationary state, determine the second instance and a periodicity of the signal-based measurement event for the one or more target candidate cells for the UE in the stationary state, and perform the measurement for the signal measurements-based event associated with the one or more target candidate cells at the second time instance based on the determined periodicity.

In an embodiment, wherein, to determine whether entry conditions for the timer-based event are completed, the instructions, when executed by the at least one processor individually or collectively, cause the UE to compare current time of the UE while performing the measurement for the timer-based event with a specified threshold time. Wherein, to determine whether entry conditions for the timer-based event are completed, the instructions, when executed by the at least one processor individually or collectively, cause the UE to determine the completion of the measurement for the timer-based event when the current time of the UE is greater than or equal to the specified threshold time.

In an embodiment, wherein, to determine whether entry conditions for the distance-based event is completed, the instructions, when executed by the at least one processor individually or collectively, cause the UE to determine distance between a current location of the UE with respect to a first reference location and second reference location. Wherein, to determine whether entry conditions for the distance-based event is completed, the instructions, when executed by the at least one processor individually or collectively, cause the UE to determine completion of the measurement for the distance-based event when at least one of the distance between the current location of the UE and first reference location becomes greater than a specified first threshold of the first reference location and distance between the current location of the UE and second reference point becomes shorter than a specified second threshold of the second reference location.

In an embodiment, wherein, to perform measurement configuration from a source cell to a selected target candidate cell of the one or more target candidate cells, the instructions, when executed by the at least one processor individually or collectively, cause the UE to determine whether the UE is in one of a mobility state or a stationary state. Wherein, to perform measurement configuration from a source cell to a selected target candidate cell of the one or more target candidate cells, the instructions, when executed by the at least one processor individually or collectively, cause the UE to perform one of based on the UE being in the stationary state, skipping the measurement for the distance-based event; and performing at least one of the measurement for the signal measurements-based event with reduced periodicity until the t-service timer is about expire for the serving cell or performing the measurement for the signal measurements-based event with increased periodicity when the t-service timer is about to expire, or based on the being in the mobility state, performing the measurement for the distance-based event continuously; and performing the measurement for the signal measurements-based event with reduced periodicity until the measurement for the distance-based event is determined to be completed.

According to embodiments, a user equipment (UE) for handling a conditional handover (CHO) in non-territorial network (NTN) may comprise at least one processor, comprising processing circuitry. The UE may comprise memory, comprising one or more storage media, storing instructions, wherein the instructions, when executed by the at least one processor individually or collectively, cause the UE to receive CHO configuration information associated with one or more target candidate cells, wherein the CHO configuration information includes a signal measurements-based event and a distance-based event based on the UE being in a connected mode for 5G services and the UE being in a stationary state. Wherein the instructions, when executed by the at least one processor individually or collectively, cause the UE to skip a measurement for the distance-based event associated with the one or more target candidate cells at a first time instance. Wherein the instructions, when executed by the at least one processor individually or collectively, cause the UE to determine whether a t-service timer meets a t-service timer expiry threshold. Wherein the instructions, when executed by the at least one processor individually or collectively, cause the UE to start a measurement for the signal measurements-based event associated with the one or more target candidate cells at a second time instance, in accordance with a determination that the t-service timer meets the t-service timer expiry threshold.

In an embodiment, wherein the instructions, when executed by the at least one processor individually or collectively, cause the UE to determine whether an entry condition for the signal measurements-based event and the distance-based event is completed. Wherein the instructions, when executed by the at least one processor individually or collectively, cause the UE to perform a CHO procedure from a source cell to a selected target candidate cell of the one or more target candidate cells based on the entry condition for the signal measurements-based event and the distance-based event being completed.

In an embodiment, wherein, to perform the measurement for the signal measurements-based event at the second time instance, the instructions, when executed by the at least one processor individually or collectively, cause the UE to determine whether the UE is in one of a mobility state or a stationary state. Wherein, to perform the measurement for the signal measurements-based event at the second time instance, the instructions, when executed by the at least one processor individually or collectively, cause the UE to perform one of based on the UE being in the mobility state, determine the second instance and a periodicity of the signal measurements-based event for the one or more target candidate cells for the UE in the mobility state, and perform the measurement for the signal measurements-based event associated with the one or more target candidate cells at the second time instance based on the determined periodicity, or based on the UE being in the stationary state, determine the second instance and a periodicity of the signal based measurement event for the one or more target candidate cells for the UE in the stationary state, and perform the measurement for the signal measurements-based event associated with the one or more target candidate cells at the second time instance based on the determined periodicity.

What is claimed is:

1. A method performed by a user equipment (UE) for handling a conditional handover (CHO) in non-terrestrial network (NTN) comprises:
receiving, by the UE, CHO configuration information associated with one or more target candidate cells, wherein the CHO configuration information includes a signal measurements-based event and one of a timer-based event or a distance-based event;
starting, by the UE, a measurement for one of the timer-based event or the distance-based event associated with the one or more target candidate cells at a first time instance;
determining, by the UE, whether the measurement for one of the timer-based event or the distance-based event is completed;
performing, by the UE, a measurement for the signal measurements-based event associated with the one or more target candidate cells at a second time instance, in accordance with a determination that the measurement for one of the timer-based event or the distance-based event is completed.

2. The method as claimed in claim 1, further comprising:
determining, by the UE, whether an entry condition for the signal measurements-based event and one of the timer-based event or the distance-based event is completed; and
performing, by the UE, one of:
a CHO procedure from a source cell to a selected target candidate cell of the one or more target candidate cells, based on the entry condition for the signal measurements-based event and one of the timer-based event or the distance-based event being completed, or
measurement configuration from a source cell to a selected target candidate cell of the one or more target candidate cells, based on the entry condition for the signal measurements-based event and the distance-based event being completed.

3. The method as claimed in claim 1, wherein the CHO configuration information includes the timer-based event when the UE is in connected mode for 5G services, wherein the CHO configuration information includes the distance-based event when the UE is in connected mode for 5G services and the UE is in at least one of a mobility state and a stationary state.

4. The method as claimed in claim 1, wherein performing the measurement for the signal measurements-based event at the second time instance comprises:
determining, by the UE, whether the UE is in one of a mobility state or a stationary state;
performing, by the UE, one of:
based on the UE being in the mobility state, determining the second instance and a periodicity of the signal measurements-based event for the one or more target candidate cells for the UE in the mobility state, and performing the measurement for the signal measurements-based event associated with the one or more target candidate cells at the second time instance based on the determined periodicity, and
based on the UE being in the stationary state, determining the second instance and a periodicity of the signal measurements-based event for the one or more target candidate cells for the UE in the stationary state, and performing the measurement for the signal measurements-based event associated with the one or more target candidate cells at the second time instance based on the determined periodicity.

5. The method as claimed in claim 1, wherein determining, by the UE, whether entry conditions for the timer-based event is completed comprises:
comparing, by the UE, current time of the UE while performing the measurement for the timer-based event with a specified threshold time; and
determining, the completion of the measurement for the timer-based event when the current time of the UE is greater than or equal to the specified threshold time.

6. The method as claimed in claim 1, wherein determining whether the measurement for the distance-based event is completed comprises:
determining, by the UE, distance between a current location of the UE with respect to a first reference location and second reference location;
determining, by the UE, completion of the measurement for the distance-based event based on at least one of the distance between the current location of the UE and first reference location being greater than a specified first threshold of the first reference location and distance between the current location of the UE and second reference point being shorter than preconfigured second threshold of the second reference location.

7. The method as claimed in claim 2, wherein performing the measurement configuration from the source cell to the selected target candidate cell of the one or more target candidate cells comprises:
determining, by the UE, whether the UE is in one of a mobility state or a stationary state;
performing one of:
based on the UE being in stationary state, skipping the measurement for the distance-based event; and performing at least one of the measurement for the signal measurements-based event with reduced periodicity until the t-service timer is about expire for the serving cell or performing the measurement for the signal measurements-based event with increased periodicity based on the t-service timer being about to expire; or
based on the UE being in mobility state, performing the measurement for the distance-based event continuously; and performing the measurement for the signal measurements-based event with reduced periodicity until the measurement for the distance-based event is determined to be completed.

8. A method performed by a user equipment (UE) for handling a conditional handover (CHO) in non-territorial network (NTN) comprises:
receiving, by the UE, CHO configuration information associated with one or more target candidate cells, wherein the CHO configuration information includes a signal measurements-based event and a distance-based event based on the UE being in a connected mode for 5G services and the UE being in a stationary state;
skipping, by the UE, a measurement for the distance-based event associated with the one or more target candidate cells at a first time instance;
determining, by the UE, whether a t-service timer meets a t-service timer expiry threshold; and
starting, by the UE, a measurement for the signal measurements-based event associated with the one or more target candidate cells at a second time instance, in accordance with a determination that the t-service timer meets the t-service timer expiry threshold.

9. The method as claimed in claim 8, further comprising:
determining, by the UE, whether an entry condition for the signal measurements-based event and the distance-based event is completed; and
performing, by the UE, a CHO procedure from a source cell to a selected target candidate cell of the one or more target candidate cells based on the entry condition for the signal measurements-based event and the distance-based event being completed.

10. The method as claimed in claim 8, wherein performing the measurement for the signal measurements-based event at the second time instance comprises:
determining, by the UE, whether the UE is in one of a mobility state or a stationary state;
performing, by the UE, one of:
based on the UE being in the mobility state, determining the second instance and a periodicity of the signal-based measurement event for the one or more target candidate cells for the UE in the mobility state, and performing the measurement for the signal measurements-based event associated with the one or more target candidate cells at the second time instance based on the determined periodicity, and
based on the UE being in the stationary state, determining the second instance and a periodicity of the signal-based measurement event for the one or more target candidate cells for the UE in the stationary state, and performing the measurement for the signal measurements-based event associated with the one or more target candidate cells at the second time instance based on the determined periodicity.

11. A user equipment (UE) for handling a conditional handover (CHO) in non-terrestrial network (NTN) comprises:
at least one processor, comprising processing circuitry; and
memory, comprising one or more storage media, storing instructions,
wherein the instructions, when executed by the at least one processor individually or collectively, cause the UE to:
receive CHO configuration information associated with one or more target candidate cells, wherein the CHO configuration information includes a signal measurements-based event and one of a timer-based event or a distance-based event;
start a measurement for one of the timer-based event or the distance-based event associated with the one or more target candidate cells at a first time instance;
determine whether the measurement for one of the timer-based event or the distance-based event is completed;
perform a measurement for the signal-measurements-based event associated with the one or more target candidate cells at a second time instance,
in accordance with a determination that the measurement for one of the time-based based event or the distance-based event being completed.

12. The UE as claimed in claim 11, wherein the instructions, when executed by the at least one processor individually or collectively, ca use the UE to:
determine whether an entry condition for the signal measurements-based event and one of the timer-based event or the distance-based event is completed; and
perform one of a CHO procedure from a source cell to a selected target candidate cell of the one or more target candidate cells, based on the entry condition for the signal measurements-based event and one of the timer-based event or the distance-based event being completed; or
perform measurement configuration from a source cell to a selected target candidate cell of the one or more target candidate cells, based on the entry condition for the signal measurements-based event and distance-based event being completed.

13. The UE as claimed in claim 11, wherein the CHO configuration information includes the timer-based event based on the UE being in a connected mode for 5G services, wherein the CHO configuration information includes the distance-based event based on the UE being in a connected mode for 5G services and the UE being in at least one of a mobility state and a stationary state.

14. The UE as claimed in claim 11, wherein, to perform the measurement for the signal measurements-based event at the second time instance, the instructions, when executed by the at least one processor individually or collectively, ca use the UE to:
determine whether the UE is in one of a mobility state or a stationary state;
perform one of:
based on the UE being in the mobility state, determine the second instance and a periodicity of the signal measurements-based event for the one or more target candidate cells for the UE in the mobility state, and perform the measurement for the signal measurements-based event associated with the one or more target candidate cells at the second time instance based on the determined periodicity, and
based on the UE being in the stationary state, determine the second instance and a periodicity of the signal-based measurement event for the one or more target candidate cells for the UE in the stationary state, and perform the measurement for the signal measurements-based event associated with the one or more target candidate cells at the seeond time instance based on the determined periodicity.

15. The UE as claimed in claim 11, wherein, to determine whether entry conditions for the timer-based event are completed, the instructions, when executed by the at least one processor individually or collectively, ca use the UE to:
compare current time of the UE while performing the measurement for the timer-based event with a specified threshold time; and
determine the completion of the measurement for the timer-based event when the current time of the UE is greater than or equal to the specified threshold time.

16. The UE as claimed in claim 11, wherein, to determine whether entry conditions for the distance-based event is completed, the instructions, when executed by the at least one processor individually or collectively, ca use the UE to:
determine distance between a current location of the UE with respect to a first reference location and second reference location;
determine completion of the measurement for the distance-based event when at least one of the distance between the current location of the UE and first reference location becomes greater than a specified first threshold of the first reference location and distance between the current location of the UE and second reference point becomes shorter than a specified second threshold of the second reference location.

17. The UE as claimed in claim 12, wherein, to perform measurement configuration from a source cell to a selected target candidate cell of the one or more target candidate cells, the instructions, when executed by the at least one processor individually or collectively, ca use the UE to:
determine whether the UE is in one of a mobility state or a stationary state;
perform one of:
based on the UE being in the stationary state, skipping the measurement for the distance-based event; and performing at least one of the measurement for the signal measurements-based event with reduced periodicity until the t-service timer is about expire for the serving cell or performing the measurement for the signal measurements-based event with increased periodicity when the t-service timer is about to expire; or
based on the being in the mobility state, performing the measurement for the distance-based event continuously; and performing the measurement for the signal measurements-based event with reduced periodicity until the measurement for the distance-based event is determined to be completed.

18. A user equipment (UE) for handling a conditional handover (CHO) in non-territorial network (NTN) comprises:
at least one processor, comprising processing circuitry; and
memory, comprising one or more storage media, storing instructions,
wherein the instructions, when executed by the at least one processor individually or collectively, cause the UE to:
receive CHO configuration information associated with one or more target candidate cells, wherein the CHO configuration information includes a signal measurements-based event and a distance-based event based on the UE being in a connected mode for 5G services and the UE being in a stationary state;
skip a measurement for the distance-based event associated with the one or more target candidate cells at a first time instance;
determine whether a t-service timer meets a t-service timer expiry threshold; and
start a measurement for the signal measurements-based event associated with the one or more target candidate cells at a second time instance, in accordance with a determination that the t-service timer meets the t-service timer expiry threshold.

19. The UE as claimed in claim 18, wherein the instructions, when executed by the at least one processor individually or collectively, ca use the UE to:
determine whether an entry condition for the signal measurements-based event and the distance-based event is completed; and
perform a CHO procedure from a source cell to a selected target candidate cell of the one or more target candidate cells based on the entry condition for the signal measurements-based event and the distance-based event being completed.

20. The UE as claimed in claim 18, wherein, to perform the measurement for the signal measurements-based event at the second time instance, the instructions, when executed by the at least one processor individually or collectively, ca use the UE to:
determine whether the UE is in one of a mobility state or a stationary state;
perform one of:
based on the UE being in the mobility state, determine the second instance and aperiodicity of the signal measurements-based event for the one or more target candidate cells for the UE in the mobility state, and perform the measurement for the signal measurements-based event associated with the one or more target candidate cells at the second time instance based on the determined periodicity, and
based on the UE being in the stationary state, determine the second instance and a periodicity of the signal based measurement event for the one or more target candidate cells for the UE in the stationary state, and perform the measurement for the signal measurements-based event associated with the one or more target candidate cells at the second time instance based on the determined periodicity.
